(19) United States
(12) Patent Application Publication
(10) Pub. No.: US 2018/0315149 A1
(43) Pub. Date: Nov. 1, 2018

(54) Method and System for Facilitating the Movements of a Set of Pedestrians by Means of a Set of Vehicles

(71) Applicant: Daniel Stona, Genève (CH)

(72) Inventor: Daniel Stona, Genève (CH)

(21) Appl. No.: 15/769,330

(22) PCT Filed: Oct. 13, 2016
(86) PCT No.: PCT/IB2016/001488

§ 371 Date: Apr. 18, 2018

(30) Foreign Application Priority Data
Oct. 19, 2015 (CH) 01512/15
Oct. 19, 2015 (CH) 01513/15
Oct. 19, 2015 (CH) 01516/15
Dec. 4, 2015 (EP) 15003451.0
Dec. 6, 2015 (CH) 01773/15
Dec. 7, 2015 (FR) 1502546
Dec. 12, 2015 (CH) 01821/15
Dec. 14, 2015 (EP) 15003547.5
Jan. 21, 2016 (CH) 00081/16
Apr. 8, 2016 (CH) 00462/16

(51) Int. Cl. G06Q 50/30; G08G 1/00; G06Q 30/06

(52) U.S. Cl. CPC G06Q 50/30; G06Q 30/0611; G08G 1/202

(57) ABSTRACT

The invention concerns a method for facilitating the movements of a set of (Ep) of pedestrians (P) each with a portable terminal (TP), by using a set of (Ev) of vehicles (V) each associated or equipped with a terminal (TV), said terminals (TP, TV) having or being associated with devices for detecting their current positions (GLP, GLV), said method including the following steps:
emission by pedestrians (P) of requests for transport, each request including at least the current position (GLP) and the destination (DP) of the pedestrian concerned;
emission by vehicles (V) or their drivers of offers of transport, each offer including at least the current position (GLV) and the destination (DV) of the vehicle concerned ;
reception by a server (S) of the requests and offers of transport;
constitution by the server (S) of a set (Ep) of pedestrian (P) asking for a transport,
constitution by the server (S) of a set (Ev) of vehicles (V) offering a transport,
search by the server (S), for each of the pedestrians (Pi) of the set (Ep), for a vehicle (Vj) of the set (Ev) having a route compatible with that of the pedestrian (Pi) and formation of compatibility couples [pedestrian (Pi); vehicle (Vj)];
for each compatibility couple [pedestrian (Pi); vehicle (Vj)]:
   delivery by the server (S) to the pedestrian (PI) of each compatibility couple (pedestrian (Pi); vehicle (V1)), a signal of possibility of transport and a request for acceptance/refusal of the transport;
   if the pedestrian (Pi) sends a refusal response to the server (s), return to the previous search step (s) by the server (S);
   in the case of a pedestrian (Pi) transmission of an acceptance response, sending by the server (S) to the vehicle (Vj) or its driver, of a signal of possibility of transport and a request to accept/refuse the transport;
   if the vehicle (Vj) or its driver sends a refusal response to the server (s), return to the previous search step by the server (S) and optional sending by the server (S) to the pedestrian (Pi) of a transport refusal signal;
   if the vehicle (Vj) or its driver sends to the server (s) an acceptance response, optional sending by the server (S) to the pedestrian (Pi) of a transport confirmation signal;
      wherein, for each compatibility couple [pedestrian (Pi); vehicle (Vj)]:
each transport request includes recent personal data (DFPi) relating to the pedestrian (Pi);
each transport offer includes recent personal data (DFVJ) relating to the vehicle driver (Vj);
   and wherein
the signal of possibility of transport sent to the pedestrian (Pi) includes said recent personal data (DFVj) relating to the driver of the vehicle (Vj);
the signal of possibility of transport sent to the driver of the vehicle (Vj) includes said recent personal data (DFPi) relating to the pedestrian (Pi).

The invention concerns a method and a system for facilitating the movements of a set of pedestrians by means of a set of vehicles. This process and this system are aimed particularly at urban areas.

### BACKGROUND OF THE INVENTION

We know of systems for connecting drivers and passengers such as that known as Blablacar®. These systems impose both drivers and passengers to seize, in addition to their destinations, the dates and times of their travels, and to make an appointment with each other.

It would be useful to have a more flexible and quicker system allowing a pedestrian to easily find a vehicle to take him to his destination. This system would be even more interesting if it offered a driver wishing to take a passenger the possibility of deciding at the last moment and if he spared, both to the pedestrian future passenger and to the driver, a tedious appointment making.

Various solutions have been proposed in patent applications published under the numbers EP 1 251 475, DE 10 2009 056641, DE 10 2010 003610, WO 2007/139375, US 2008/277183, WO 2013/001553 and FR 2 908 210.

Among the obstacles that prevent the development of these systems, one can list the following:
Too much complication: it is necessary to propose a simple solution if it is to be used by a maximum number of people, especially young people who jump from one novelty to another, or the elderly sometimes lost in the face of new Technologies;
A lack of responsiveness to the system
A lack of flexibility in the system For example, some prior art systems do not provide for the case where a passenger could be transported on a portion of a vehicle's itinerary;
And, certainly the greatest obstacle of all, security: it goes without saying that it may not be reassuring to ride in an unknown vehicle leads not an unknown person, in particular, in the case of a driver (man) and a passenger.

Finally, it is imperative that these systems do not disturb or at least affect the normal circulation as little as possible, that they are less likely to deconcentrate the drivers so as not to increase the risk of accidents, that they do not increase the Consumption of fossil fuels, by not lengthening the routes of users, that they promote carpooling and thus reduce the number of vehicles traffic and consequently the emissions of exhaust gas which are for a large part of the gases Greenhouse effect.

In addition, in order for such a system to be successful, it must not lead to an additional cost to the driver or pedestrian, for example by imposing on them the purchase of equipment to be able to implement this system.

### SUMMARY OF THE INVENTION

The main purpose of the invention is to propose solutions overcoming the aforementioned obstacles. This goal is achieved through a method of facilitating the movement of a set (Ep) of pedestrians (P) each with a portable terminal (TP), by using a set of (Ev) of vehicles (V) each associated or equipped with a terminal (TV), said terminals (TP, TV) having or being associated with devices for detecting their current positions (GLP, GLV), said method including the following steps:

emission by pedestrians (P) of requests for transport, each request including at least the current position (GLP) and the destination (DP) of the pedestrian concerned;

emission by vehicles (V) or their drivers of offers of transport, each offer including at least the current position (GLV) and the destination (DV) of the vehicle concerned;

reception by a server (S) of the requests and offers of transport;

constitution by the server (S) of a set (Ep) of pedestrian (P) asking for a transport,

constitution by the server (S) of a set (Ev) of vehicles (V) offering a transport,

search by the server (S), for each of the pedestrians (Pi) of the set (Ep), for a vehicle (Vj) of the set (Ev) having a route compatible with that of the pedestrian (Pi) and formation of compatibility couples [pedestrian (Pi); vehicle (Vj)];

for each compatibility couple [pedestrian (Pi); vehicle (Vj)]:
delivery by the server (S) to the pedestrian (PI) of each compatibility couple (pedestrian (Pi); vehicle (VJ)), a signal of possibility of transport and a request for acceptance/refusal of the transport;
if the pedestrian (Pi) sends a refusal response to the server (s), return to the previous search step (s) by the server (S);
in the case of a pedestrian (Pi) transmission of an acceptance response, sending by the server (S) to the vehicle (Vj) or its driver, of a signal of possibility of transport and a request to accept/refuse the transport;
if the vehicle (Vj) or its driver sends a refusal response to the server (s), return to the previous search step by the server (S) and optional sending by the server (S) to the pedestrian (Pi) of a transport refusal signal;
if the vehicle (Vj) or its driver sends to the server (s) an acceptance response, optional sending by the server (S) to the pedestrian (Pi) of a transport confirmation signal;

wherein, for each compatibility couple [pedestrian (Pi); vehicle (Vj)]:
each transport request includes recent personal data (DFPi) relating to the pedestrian (Pi);
each transport offer includes recent personal data (DFVJ) relating to the vehicle driver (Vj);

and wherein
the signal of possibility of transport sent to the pedestrian (Pi) includes said recent personal data (DFVj) relating to the driver of the vehicle (Vj);
the signal of possibility of transport sent to the driver of the vehicle (Vj) includes said recent personal data (DFPi) relating to the pedestrian (Pi).

It goes without saying that the request for acceptance/refusal should be submitted first to the driver and then to the pedestrian. However, it is preferable to start with the pedestrian because he is at a standstill and can take his time, while the driver is probably already en route, i.e. driving his vehicle when he receives a request for acceptance/refusal and It should be disturbed as little as possible.

According to a preferred embodiment, it is foreseen in the procedure according to the invention that whenever a takeover is refused, the person who has already accepted it (normally the pedestrian) is informed of it, in order to prevent it being surprised to receive a New proposal for support when it has just accepted one or so that it does not wait indefinitely for a vehicle. It goes without saying that the person receiving the second support proposal (normally the driver) cannot receive a refusal.

Depending on a variant, the pedestrian or the driver can generally disable (e.g. in his account preferences) or punctually the display/acceptance stage of the support. This helps to speed up the operation of the system. Indeed, for example, a pedestrian in a hurry can skip this step in order to save time and thus accept to be supported by any vehicle with compatible path.

According to an advantageous embodiment of the invention, the process also includes:

a stage in which each pedestrian (PI) is taken or photographed by means of his terminal (TP) and the fresh Personal data (DFPi) relating to the Pedestrian (PI) include this photo;

a stage during which each vehicle driver (VJ) is taken or photographed by means of the terminal (TV) and the fresh Personal data (DFVJ) relating to the vehicle driver (VJ) include this photo;

the signal of the possibility of support sent to the vehicle (VJ) or its driver also includes possibly the indication of the sex of the pedestrian (Pi); and

the signal of the possibility of support sent to the pedestrian (Pi) also includes possibly the indication of the sex of the driver of the vehicle (VJ).

The photo taken by another person or by oneself (commonly referred to as “selfie” for “photographic Autoportation” or “égoportrait”) is interesting, on the one hand, because it is taken using the pedestrian or conductor terminal, i.e. with the Terminal used for the implementation of the process, and on the other hand It allows the travel partner to be sure that the person he or she is travelling with is the one that is visible in the photo.

Moreover, it allows a rapid mutual recognition and therefore a rapid ascent in the vehicle, which avoids too disturbing the traffic.

According to a preferred embodiment of the invention, requests for acceptance/refusal of support are valid for a specified period of time; If at the end of that period, the pedestrian (PI) or the driver of the vehicle (VJ) did not respond, it is considered that his answer is negative and there is back to the server search step of compatibility and formation of compatibility pairs [Pedestrian (pi) ; Vehicle (VJ)].

It can also be foreseen that the aforementioned specified duration given to the driver is longer than that given to the pedestrian. In fact, if the driver is driving his vehicle, it is advisable that he consult his terminal to make his decision only at a time that is safe for them, for example, when the vehicle is stationary in front of a red traffic light.

The invention also relates to a system for facilitating the movement of an Ep of pedestrians P by means of an Ev set of V vehicles, comprising:

At least one TP terminal intended for pedestrian P and having a device for determining its current position GLP,

At least one TV terminal intended or associated with a vehicle V and having a device for determining its current GLV position, and

S Server,

And in which:
The terminal (s)/TP and the terminal/TV are suitable and configured to communicate wirelessly with the server
The S server is fit and configured to communicate wirelessly with the TP, TV terminals;
The different configurations being able to implement the process according to the invention.

Another aspect is that the invention relates to a method of determining the compatibility of the IP route of a pedestrian P equipped with a portable TP terminal with Route IV of a vehicle V equipped with a TV terminal, with a view to the latter's assumption of Pedestrian P, including the following steps:

Entering or dictated by the pedestrian P from its DP destination to its TP terminal or reading by that terminal of a code corresponding to the DP destination;

Determination by the TP terminal of its current position GLP;

Sending by the TP terminal of the DP destination as well as the current GLP position to an S server;

Entering or dictated by the driver of the vehicle V to the TV terminal of the DV destination of the vehicle V or reading by that terminal of a code corresponding to the DV destination;

Determination by the TV terminal of its current GLV position;

Sending by the TV terminal of the DV destination as well as the current position GLV to the server S;

Reception by the server S of the current positions GLP, GLV and DP and DV destinations of pedestrian P and vehicle V;

Calculation by the server S, for each of the points of Route IV of vehicle V, of the distance d0 between the point considered and the pedestrian P and comparison of this distance d0 with a maximum distance predetermined dmax;

If for all points, the d0 distance is greater than dmax, there is an incompatibility of the IP and IV routes; Possible sending by the S server to the TP terminal and/or the TV terminal of a no-compatibility signal;

If, for at least one point, the distance d0 is less than or equal to DMax:
Computation by the S server of the distance D1 between the destination P and the DV destination and comparison of that D1 distance with DMax;
If D1 is less than or equal to DMax, there is a compatibility (type 1) of the IP and IV routes;
If D1 is greater than DMax,
   Calculation by the server S, for each of the points of Route IV, of the distance D2 between the point considered and the destination DP and comparison of D2 with DMax;
   If D2 is greater than dmax for all points, the IP and IV routes are incompatible;
   If, for at least one point, D2 is less than or equal to DMax, there is compatibility (type 2) of the IP and IV routes, this point is memorized as PTmin.

The route of the vehicle V between its current position GLV and its DV destination can be calculated by the server S. It can be foreseen that the server S calculates several routes, for example the shortest in distance but not necessarily in time and the fastest but not necessarily the shortest, and asks the driver of vehicle V to choose the one he prefers. It can also be considered that the driver communicates to the server S the points (streets, intersections, buildings, etc.) by which he wishes to pass.

It is also preferable that at least one of the vehicles takes over several pedestrians and forms a pair of compatibility with each of them.

According to yet another aspect, the purpose of the invention is a method of managing the relationship of a vehicle V with a pedestrian P whose destination DP:
Is the same as the DV destination of vehicle V or is located at a distance of at most a predetermined maximum dmax of this DV destination; Or
is located on a PTmin point of Route IV of vehicle V or is not more than a predetermined maximum distance dmax from a PTmin point of that route,
   The pedestrian P being equipped with a portable terminal TP and the vehicle V being equipped with a TV terminal, these terminals TP, TV having or being associated with devices for determining their current positions GLP, GLV, this process including the following steps:

Determination by the TP terminal of its current position GLP and sending this position to the server S;

Determination by the TV terminal of the current position GLV and sending this position to a server S;

Reception by the server S of the current positions GLP and GLV;

Calculation by the server S of the current distance d3 between the vehicle V and the pedestrian P,

Comparison of D3 distance at a predetermined maximum distance da;

If D3 is greater than DA, return to previous steps;

If D3 is less than or equal to DA,
Sending the S server to the TV terminal of a vehicle stop signal V; Preferably, this signal contains fresh personal data relating to pedestrian P;
Sending the S server to the TP terminal of a signal inviting the pedestrian to join the vehicle V and to climb in; Preferably, this signal contains fresh personal data relating to the driver of vehicle V as well as preferentially data relating to the vehicle itself, advantageously, his photograph;
Sending by the TP terminal to the server S of a signal of ascent in a vehicle and/or sending by the TV terminal of a pedestrian ascent signal,
Sending the TV terminal from its current position to the server S,
In case the destination of the DV vehicle is identical or different to the maximum of dmax of the destination of the pedestrian DP (compatibility Type 1), comparison by the server S of the current position of the vehicle V with the destination DV, in case of difference, return to the previous step of sending by the TV terminal to the server S of its current position; If there is an identity, it may be sent by the server S to the TV terminal and possibly to the TP terminal of a signal arriving at destination;
In the case where the destination of the pedestrian DP is at a point PTmin of Route IV of vehicle v or distant from dmax at more than one point PTmin of this route (Type 2 compatibility), comparison by the server S of the current position of the vehicle V with the posit Ion PTmin; If there is a tie, send by the server S to the TV terminal of a stop signal for pedestrian descent and possibly to the TP terminal of a signal of arrival at destination; If not return to the previous step of sending by the TV terminal to the server S of its current position;
Optionally, the TP terminal sends an end of transport signal to the S server and/or the TV terminal sends it to the s server of a transport end signal.

It goes without saying that during all this management of the connection, the driver of the vehicle must follow the route calculated by the server S and that he has if necessary chosen among other routes proposed.

It is therefore preferable that after the calculation of the route by the server S and possibly its choice by the driver, the server s sends this route to the TV terminal so that it can display it permanently, except perhaps when there is display of Fresh personal data of the pedestrian on the terminal screen. Of course, this route can also be communicated orally by the server S Via The TV terminal. The S server can handle moving the V vehicle to its DV destination in the same way as the commercial GPS guidance systems do.

The stopping distance da can be the predetermined maximum distance dmax, especially when the system is intended to be used in a noticeably urban area.

According to a variant intended instead to the non-urban areas where vehicles circulate faster, the stopping distance da is that which is calculated in general and approximate for a motor vehicle and which is equal to the square of the number of tens of the Speed of the vehicle expressed in km/h. Thus, for a Vj vehicle moving at a VITj speed, Da is equal to (VITJ/10)×(VITJ/10), or for a car moving at 90 km/h, Da is Roughly of 81 M. As this is an approximate velocity is in principle high because it is normally a rather abrupt stop, it is likely that the vehicle requires a higher distance to stop. As DA is measured from the position of the pedestrian, this means that the vehicle will overtake the pedestrian. However, unless the pedestrian has chosen a value for DMax that is much less than the default of 50 m (as will be seen later), the vehicle will still stop at a distance from the pedestrian which is less than DMax. The basic condition, namely, that the pedestrian does not have to walk a distance greater than DMax to reach the vehicle, will therefore remain filled.

Thanks to the method of managing the connection, the task of the driver is not complicated by the presence of a passenger. It does not need to memorize the address where it must take care of the pedestrian or the address where it should be deposited. So he can stay focused on his driving, which is particularly interesting when the driver is distracted, has trouble memorizing addresses or doesn't know the places well.

On the other hand, the use of fresh personal data or recent, such as a “selfie”, is particularly advantageous because it greatly facilitates mutual recognition at the meeting of future travel partners or “Cocarrs”. Indeed, if a non-recent photo was used, certain traits of the person may have changed since, in particular, the cutting and/or hair color, the presence/absence of a beard, the tanning, the makeup, the wearing of a scarf, a cleavage, a Tattoo, etc.

Fresh Personal Data or recent are therefore data that date from the time of the request of the training of the request for support by a pedestrian and the time of the request of the training of the offer of management by a driver. This data therefore does not normally vary between the time of the request in/offer of care and the actual encounter or linking of the pedestrian and the driver. This is what gives them a safe or reassuring role.

As fresh personal data, in addition to photos or “selfies”, we can also cite moving photos that are actually Estates of Images usually in the format “.gif” and now called “Gifies”, as well as videos, preferably of short duration, videos having the advantage of having in principle sound.

According to a preferred embodiment, the method of managing the connection includes the sending by the terminal (TP) to the server (s) of an end of transport signal and the sending by the terminal (TV) to the server (s) of a signal of end of transport and these shipments are ACCOMPAG Born of a ECj evaluation of the driver of the vehicle (VJ) by the Pedestrian (PI) and an EPi evaluation of the Pedestrian (PI) by the driver of the vehicle (VJ).

According to an advantageous embodiment, it is also planned:

The calculation by the server (S) of an average of the vehicle driver's ratings (VJ) to obtain a EMCj overall average rating of the driver, the increment of 1 of the number of transports he has carried out and the storage of that information; and

The calculation by the server (S) of an average of the pedestrian ratings (Pi) to obtain a global average EMPi assessment of the driver, the increment of 1 of the number of transports it has benefited and the storage of this information.

According to another advantageous embodiment, for each compatibility pair [pedestrian (Pi); vehicle (VJ)]:

Each signal of the possibility of support sent to a pedestrian (Pi) includes the overall average EMCj assessment of the vehicle driver (VJ) and preferably also the number of transports already carried out and on the basis of which this average assessment Global EMCj has been calculated;

Each signal of the possibility of support sent to the vehicle driver (VJ) includes the overall average EMPi of the pedestrian (pi) and preferably also the number of transports whose pedestrian (PI) has benefited and on the basis of which this evaluation Overall average EMPi was calculated.

The use of the evaluations is also very interesting because the decision-making of a human being usually involving a part of rational and irrational, taking into account of its two aspects allows a better choice for the user. Thus, the rational aspect here is the mathematical average of the previous evaluations and the irrational aspect can correspond here to the desire or not to travel a person with a certain facies or a certain outfit.

This combination of rational and irrational, even intuitive, gives the user the impression of making the right decision about his travel partner.

One can even further refine decision making by distinguishing it between the sexes of people. specifically:

For each vehicle (VJ), each ECj evaluation and each end-of-transport signal received by the server (s) are stored by it in relation to the sex of the pedestrian (Pi) that has just been transported and the server (s) calculates an average of the ratings Allocated for the transport of EMCFj women and/or an average of the evaluations received for the transport of EMCHj men;

For each pedestrian (Pi), each EPi evaluation and each end-of-transport signal received by the server (s) are stored by it in relation to the sex of the vehicle driver (VJ) that has just transported it and the server (s) calculates an average of Evaluations received for travel with EMPFi conductors and/or an average of the evaluations received for travel with EMPHi drivers;

and in which
Each signal of the possibility of support sent to a pedestrian (Pi) includes
   The average of the evaluations received by the driver of the vehicle (VJ) for the transport of women EMCFj and preferably also the number of transport of women carried out and/or
   The average of the evaluations received for the transport of men EMCHj and preferably also the number of transports of men carried out;
   and possibly the overall average EMCj assessment of the vehicle driver (VJ) and possibly the total number of transports already carried out;
Each signal of possibility of support sent a vehicle (VJ) or its driver includes
   The average of the ratings received by the pedestrian (Pi) for travel with EMPFi drivers and preferably also the number of trips carried out with women and/or
   The average of the evaluations received for travel with EMPHi drivers and preferably also the number of trips made with men;
   and possibly its overall average EMPi of the pedestrian (PI) and possibly the total number of transports for which the pedestrian (PI) has benefited.

The distinction between the evaluations provided by women and those provided by men makes it possible to refine the selection of the travel partner taking into account, in particular, the fact that some men do not have the same behaviour according to which they are in Presence of a man or a woman.

At the beginning, when a pedestrian (p) or a driver of a vehicle (V) registers, if the system plans to send his or her evaluations to his potential travel partner, the default is an average rating for that pedestrian (p) or driver. For example, if possible assessments are as follows:

0: appalling, to avoid

1: Frankly bad

2: Rather bad

3: Medium

4: Good

5: Excellent,

By default the value of 3 is assigned to the pedestrian or driver who registers and will therefore use the system for the first time. In any case, if the number of transports is indicated, the travel partner will understand that it is a value that is based on the assumption that the person has a correct behavior, which is normally the case for most people.

Of course, it can be expected that the driver will indicate if and how many people travel with him or her. In this case, the system may ask it to take a picture of these people to display them simultaneously or sequentially on the pedestrian's terminal so that the person can give or not his agreement to travel with the driver and all his companions.

It goes without saying that if they are persons who have been taken over by the previous implementation of the procedure according to the invention on the same route of the vehicle, it may be planned to display in addition to the photos of these persons, their evaluations as indicated above.

The process may also include a step in archiving the data for each transport.

If one assumes that the pedestrian does not move, it is possible to foresee that its TP terminal sends only once its current position and that the stage of

Determination by the terminal (TP) of the current position of the pedestrian (P) and sending this position to the server (S);

takes place only once.

Thus, for the second step and the following stages of

Calculation by the server (S) of the current distance (D3) between the vehicle (V) and the Passenger (P),

The previous position is used, which is normally the initial position of the pedestrian P.

This prevents the TP terminal from continually sending its current position and prevents the S server from searching for this current position in the passenger base. The server then runs fewer operations and saves a little time.

The invention therefore offers a pedestrian the possibility of being taken to his destination in a very simple and quick way.

Likewise, any driver may at any time offer a free seat to a passenger, or even several free seats to as many passengers.

The invention is therefore a new type of carpool with a modern form of hitchhiking and maintains its simplicity. Indeed, it allows the management of pedestrian (p) and vehicle (v) movements, so that pedestrians (p) and drivers of vehicles (v), as human beings, physically perform the following steps only:

a single pre-stage, for each pedestrian (P) and for each vehicle (V), registration respectively in a registered pedestrian base and a registered driver's base and then

For each pedestrian (P), at least one, preferably more than one, ideally a multitude of repetitions of all the following steps only, per route:
Initiation of a program capable of implementing the process according to the invention;
Possibly, personal identification;
Communication of destination (DP);
Communication of fresh personal data, such as a photographic self-report;
Possibly, refusal of one or more proposals for management;
Acceptance of support
Confirmation of ascent in a vehicle (V);
Communication of the end of transport
Possibly, evaluation of the vehicle driver (V);

For each vehicle driver (V), at least one, preferably more than one, ideally a multitude of repetitions of all the following steps only, per route:
Initiation of a program capable of implementing the process according to the invention;
Possibly, personal identification;
Communication of its destination (DV);
Communication of fresh personal data, such as a photographic self-report;
Possibly, refusal of one or more proposals for management;
Acceptance of support
Confirmation of the ascent of a pedestrian (P) in the vehicle (V);
Eventually, communication of the end of the transport; and
Possibly, assessment of the pedestrian (P).

The remainder of the operations is carried out by the server (S), the terminal TP and the TV terminal, so that the main function of the system is invisible to the user and above all, the latter does not have to deal with it.

Other features and benefits of the invention will now be described in detail in the following presentation which is given in reference to the annexed figures, which are schematically:

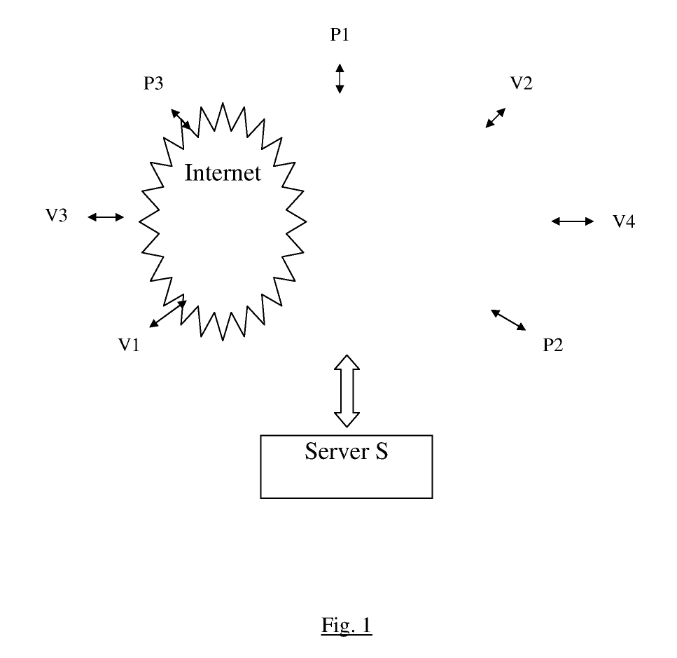

FIG. 1: A system, according to the invention, of facilitating the movement of a set of pedestrians by means of a set of vehicles;

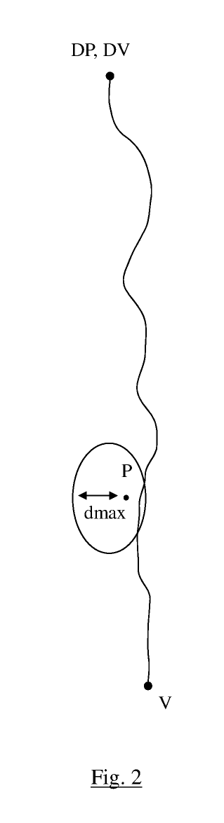

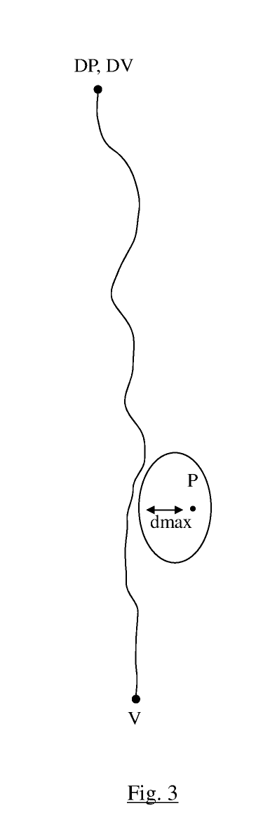

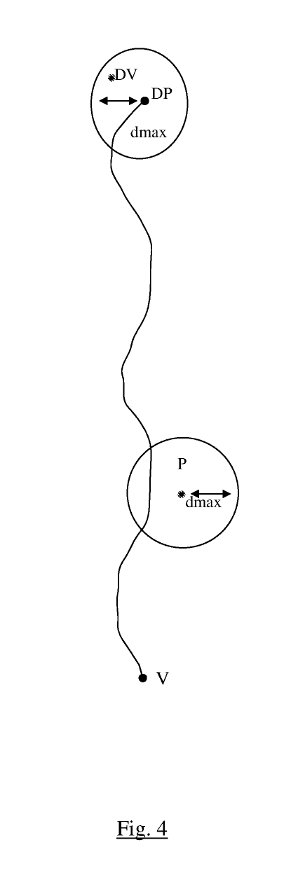

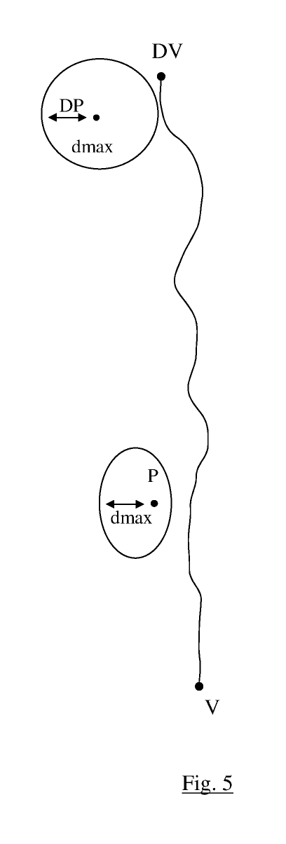

FIGS. 2 and 3: Diagrams illustrating, respectively, the possibility and the impossibility of management in a first case;

FIGS. 4 and 5: Diagrams illustrating, respectively, the possibility and the impossibility of management in a second case;

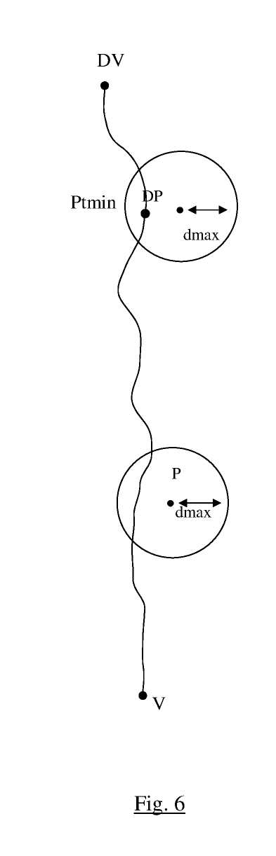

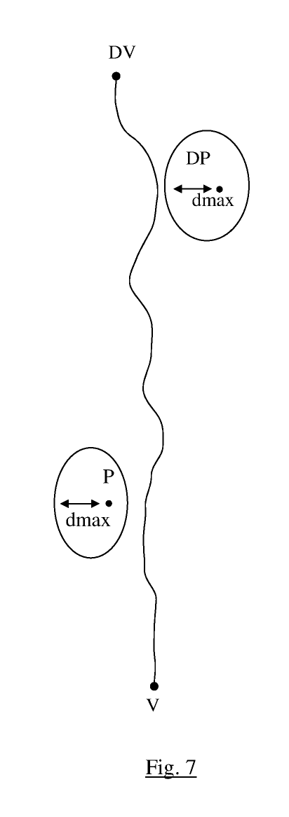

FIGS. 6 and 7: Diagrams illustrating, respectively, the possibility and the impossibility of management in a third case;

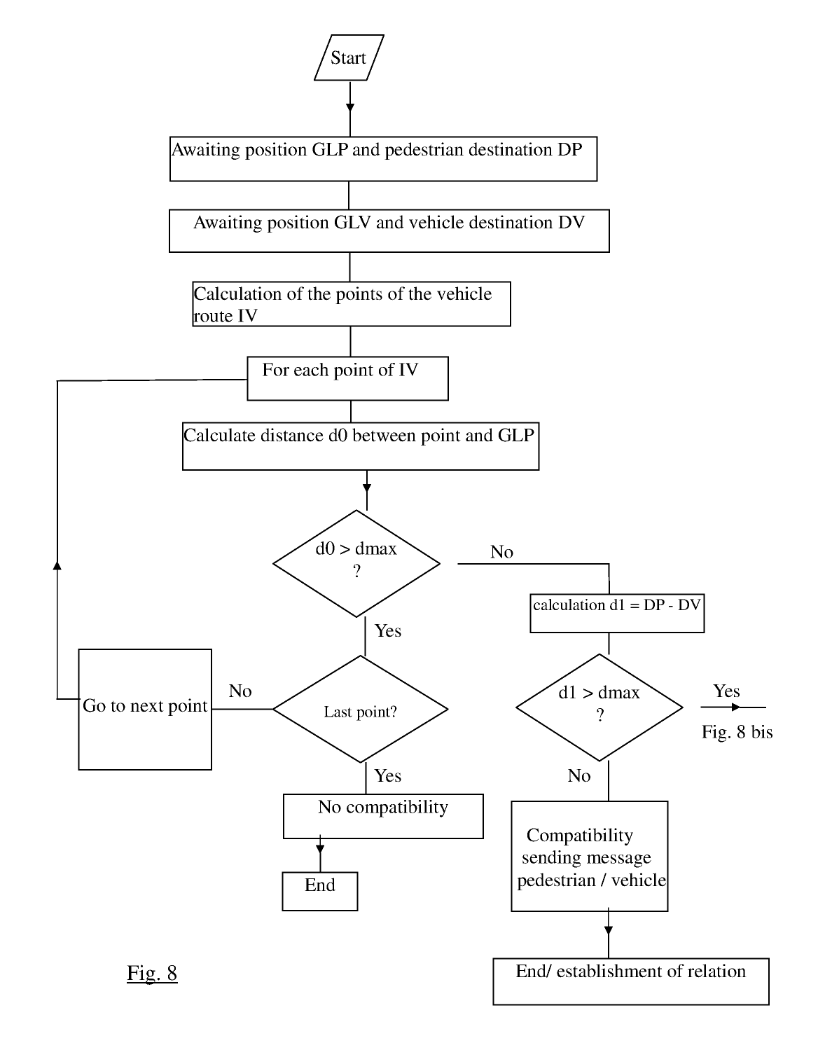

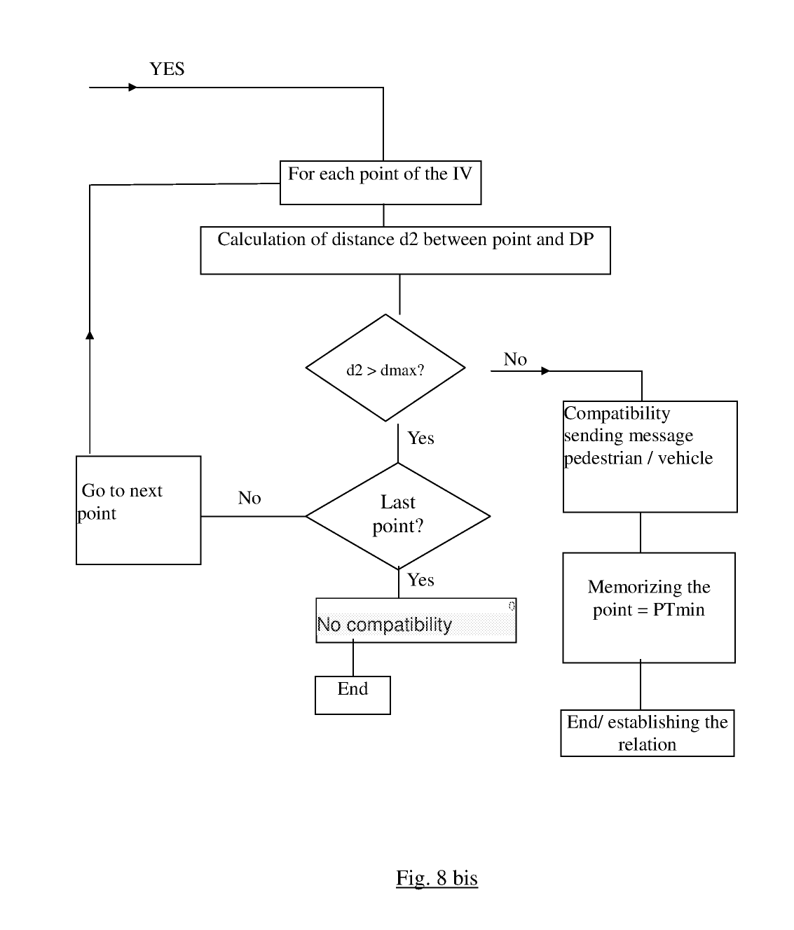

FIGS. 8 and 8bis: an example of a programme flowchart with the essential steps of the principle of determining the compatibility of destinations and routes;

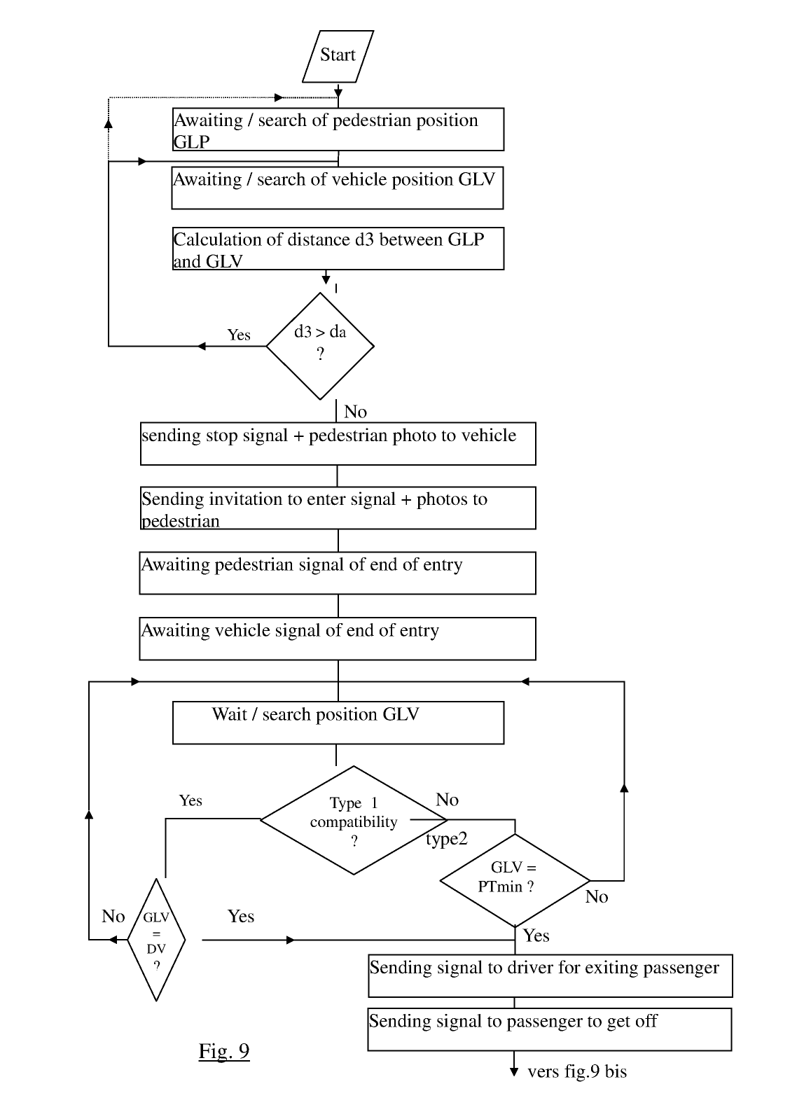

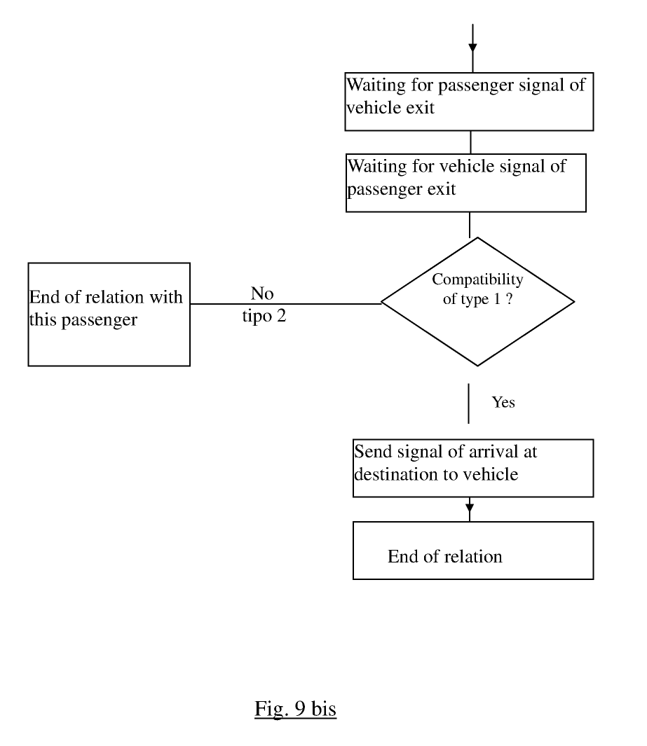

FIGS. 9 and 9bis: an example of a programme flowchart incorporating the essential steps of the principle of connecting a pedestrian with a vehicle;

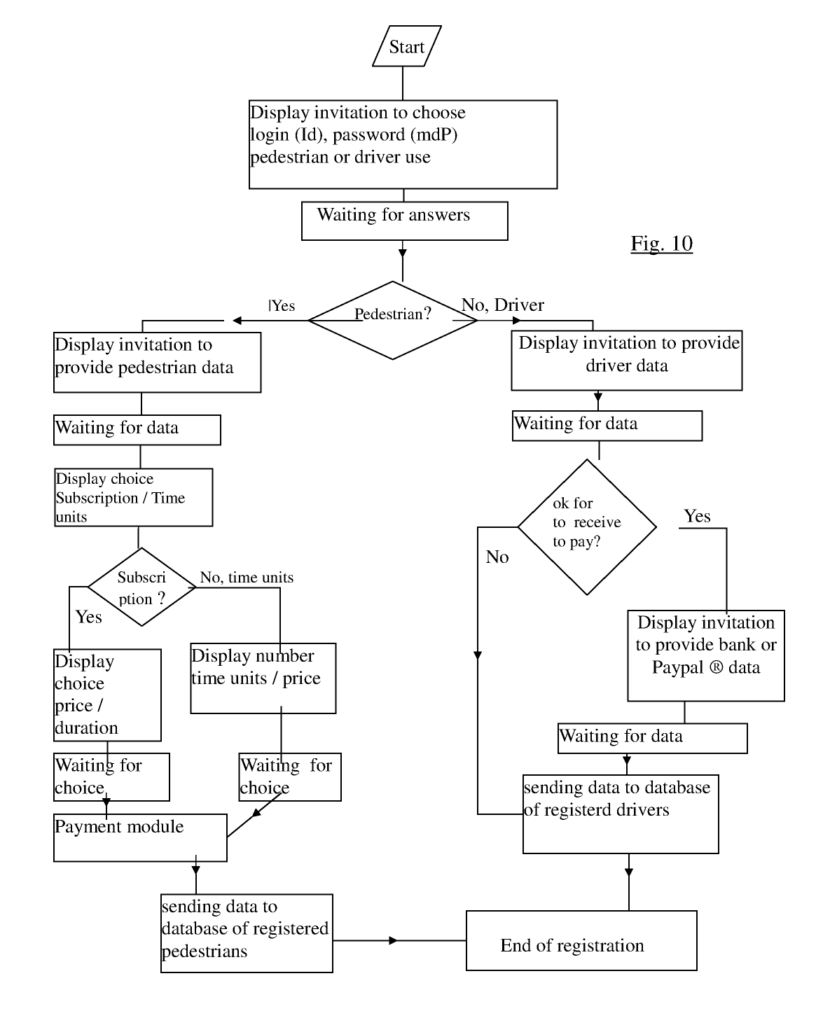

FIG. 10: An example of a program flowchart that will decline the steps of the operation of a Web site, including the pre-registration of pedestrians or drivers, so that they can use the invention;

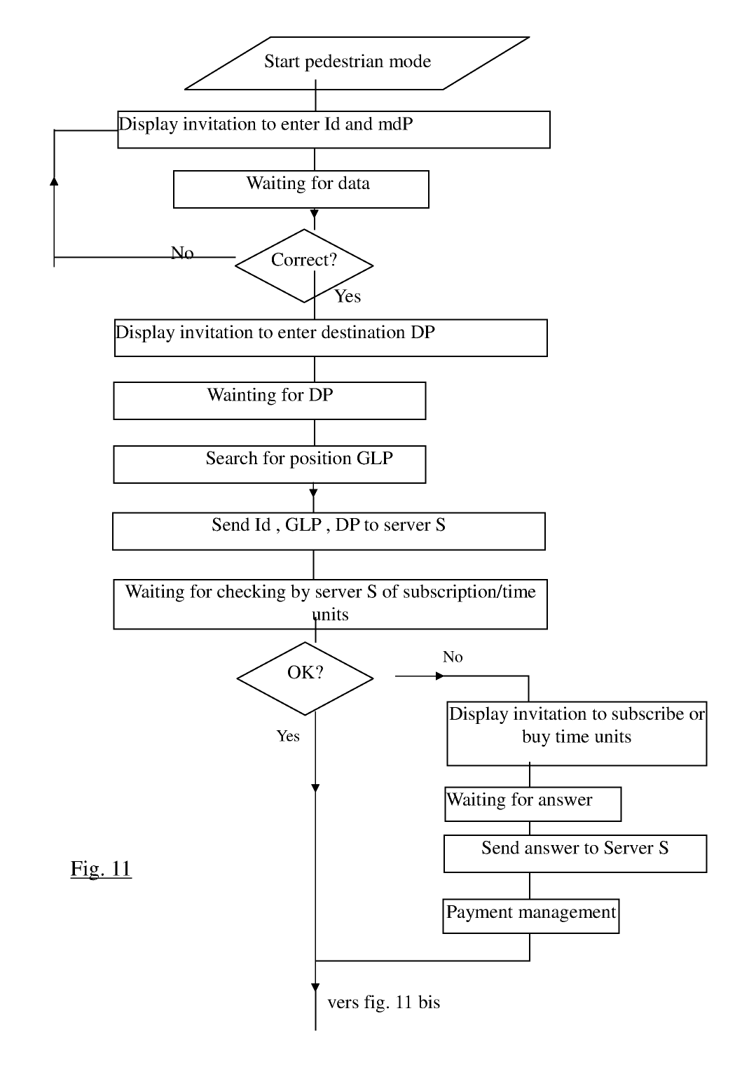

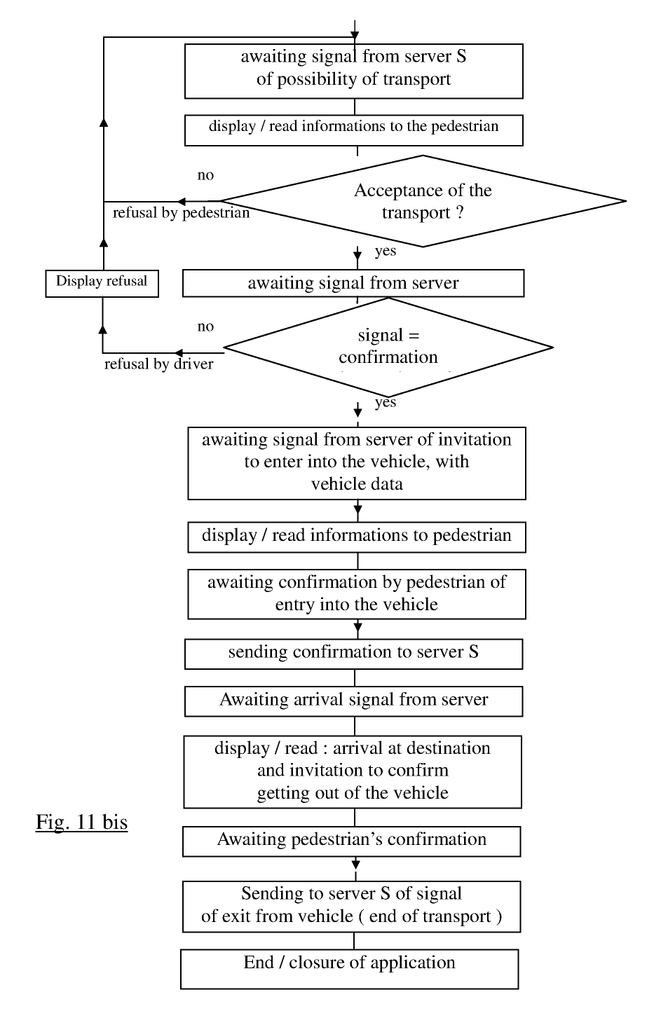

FIGS. 11 and 11bis: an example of the flowchart of a program designed to manage the functioning of a pedestrian's terminal in order to implement the invention;

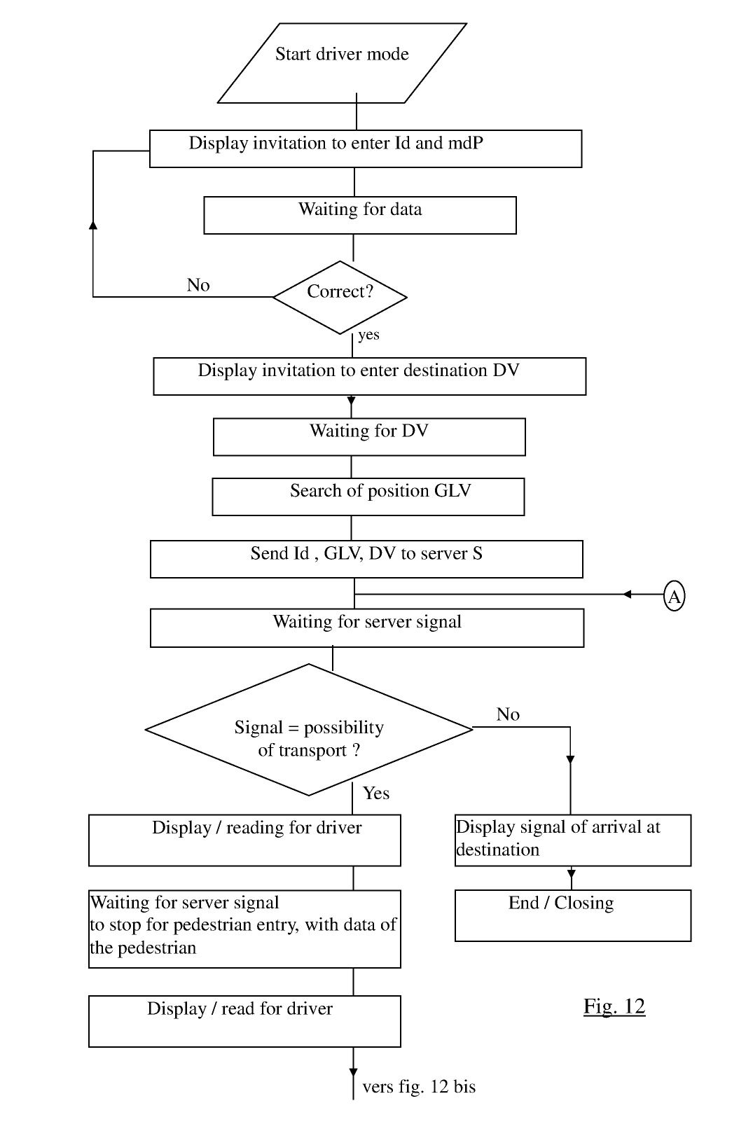

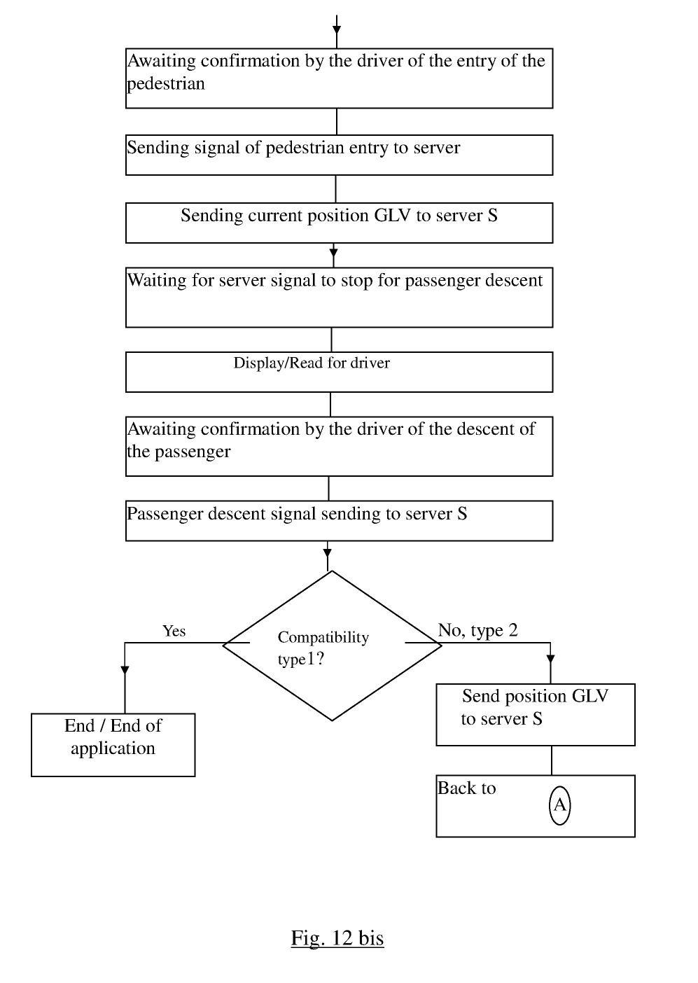

FIGS. 12 and 12bis: an example of the flowchart of a programme designed to manage the operation of the terminal of a vehicle or a driver in order to implement the invention;

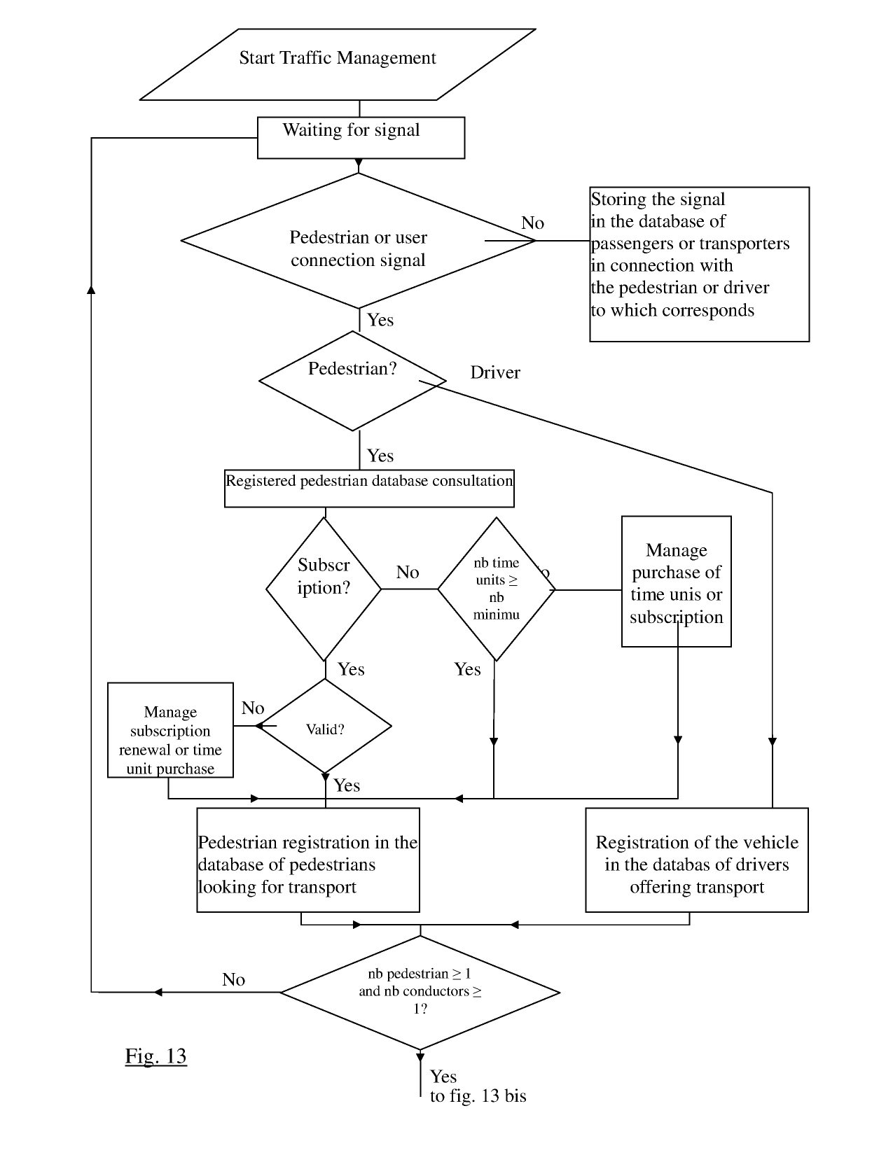

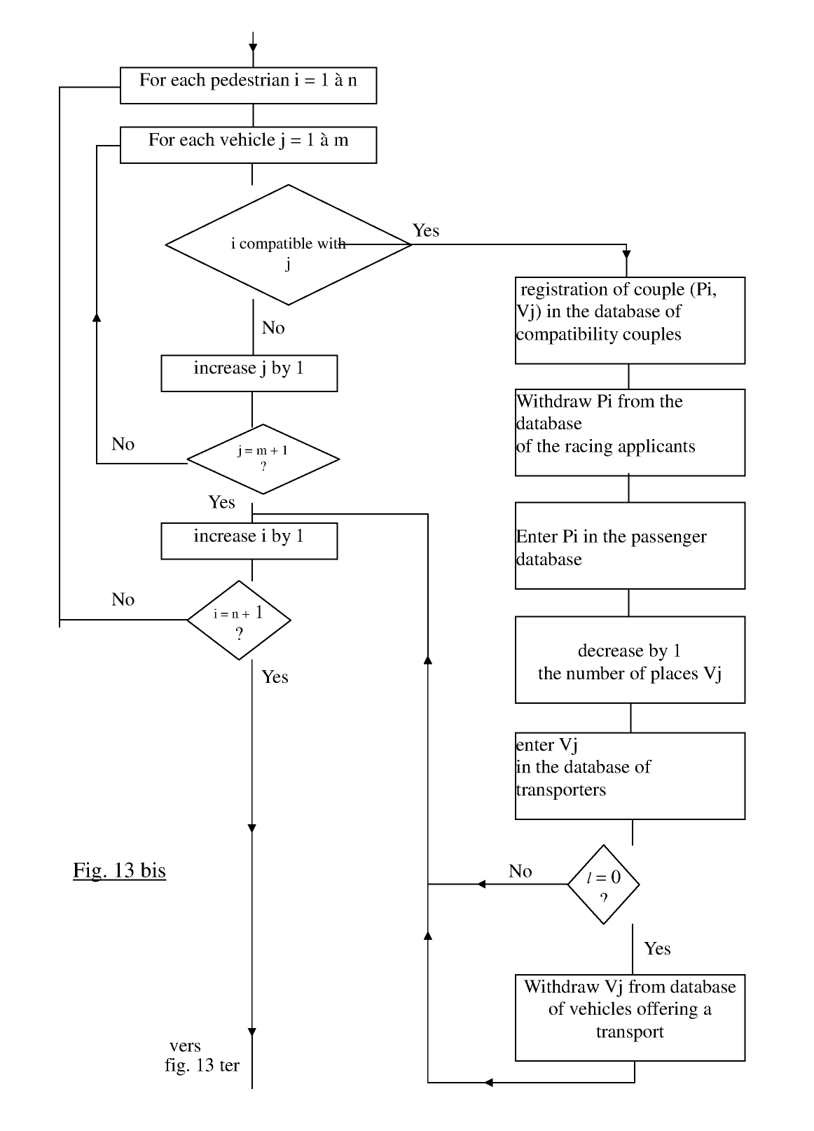

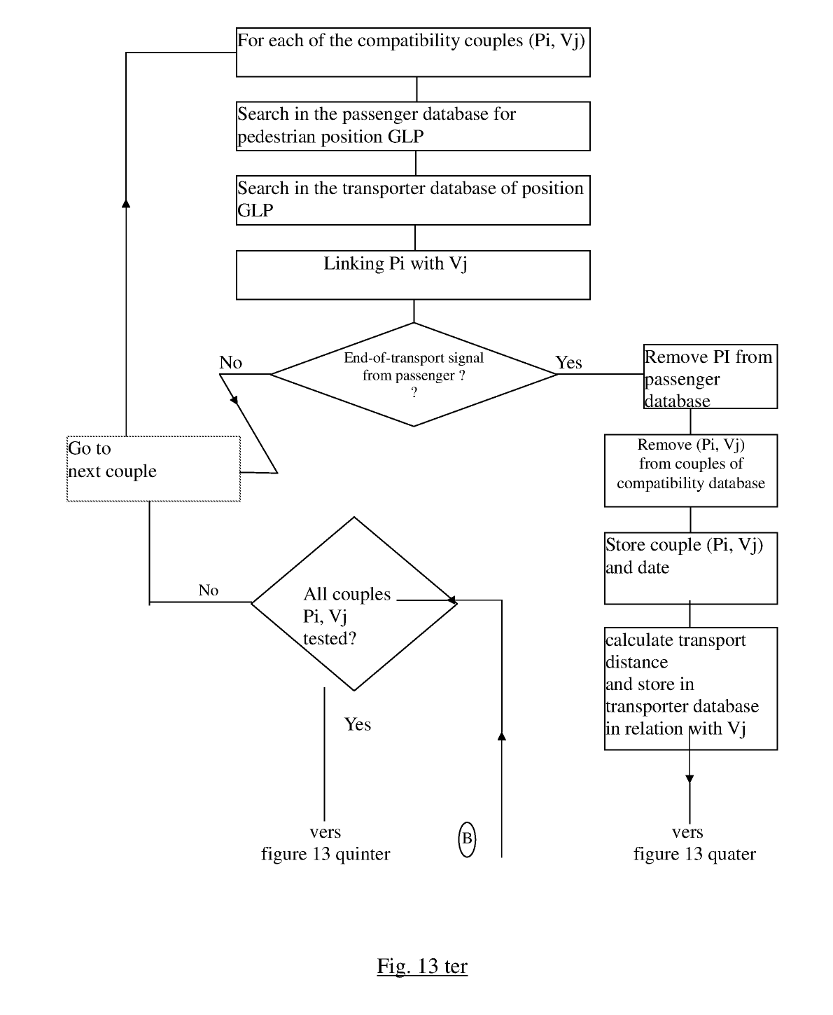

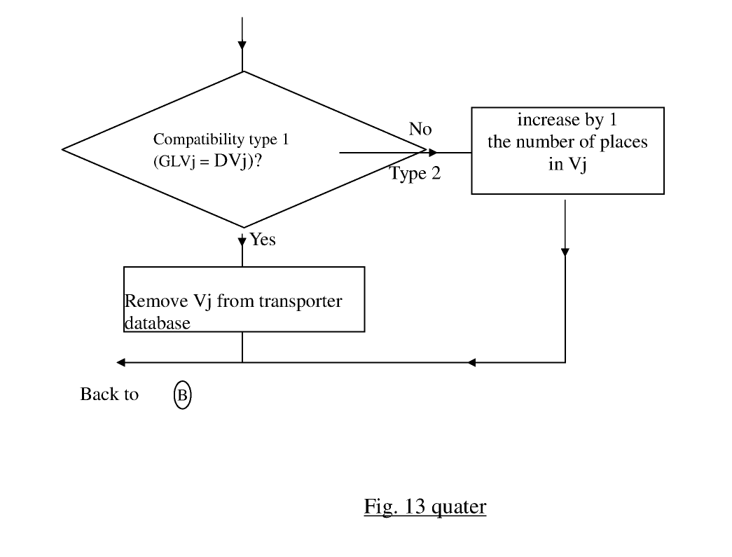

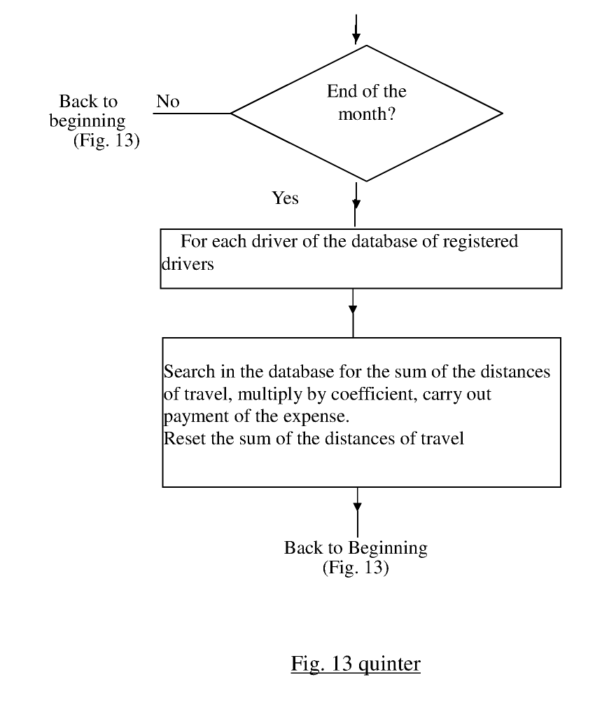

FIGS. 13quinter: Parts of an example of a program flowchart involving the essential steps of the process according to the invention of facilitating pedestrian movement through vehicles.

### DETAILED STATEMENT OF THE INVENTION

The system of facilitating the movement of a set of pedestrians by means of a set of vehicles according to the invention is illustrated in FIG. 1, on which one can see a server communicating through the Internet with vehicles V1, V2, V3 and V4 and pedestrians P1, P2 and P3.

Basic Principles

At least three elements are necessary to ensure that the invention can be implemented. It is a pedestrian P wishing to become a passenger, a vehicle V wishing to carry a passenger and a servers to connect them.

Each pedestrian P must be equipped with a TP terminal which is preferably equipped with a device for determining its current GLP position and capable of communicating with the server S for the purpose of transmitting information. Alternatively, pedestrian P may be considered to use a terminal without the device. In this case, the pedestrian P must enter his address and it can be transformed into a current position by the TP terminal and sent to the server S, unless the latter is responsible for transforming the address into a current position.

Likewise, each V-vehicle must be equipped with a TV terminal equipped with a device for determining its current position and capable of communicating information to the server S. The TV terminal can be part of the vehicle's onboard electronics or it may be the TV terminal of the vehicle driver V.

The TP and TV terminals can ordiphones such as those marketed under the name SmartPhone®, IPhone®, etc., tablets such as an IPad®, an Android tablet®etc. These devices have a powerful microprocessor enabling them to perform complex programs contained in their high-capacity memory and various communication modules by electromagnetic waves (radio, radiotelephone, telephone Portable, 3g or 4g data transmission network, etc.) Possibly through a network such as the Internet. Moreover, they have the advantage of being generally equipped with a GPS-type geolocation system.

As for the S-server, it can be a computer with at least one high-capacity memory and at least one powerful microprocessor that allows it to run complex programs. It understands or is connected to a communication module capable of communicating with the terminals TP and TV by electromagnetic waves (radio, radiotelephone, mobile phone, 3g or 4g network of data transmission, etc.) possibly via Network such as the Internet. Preferably, the system used is the one that allows the fastest speed of data transmission.

Determination of the Possibility of Taking Charge of a Pedestrian P by a Vehicle V

This possibility of support can in fact also be referred to as “compatibility of the routes of pedestrian P and vehicle V”.

In order for a vehicle V to be able to support a pedestrian p future passenger, it is necessary that he can first physically meet this pedestrian p, normally without altering his itinerary.

Several cases can then be considered. They are diagrammed on FIGS. 2 to 7 where a pedestrian P wishing to go to his destination DP and a vehicle V wishing to go to his destination DV are represented.

The pedestrian P is assumed to be stationary to simplify the demonstration. He is only willing to walk a limited distance to reach a V vehicle or to reach his DP destination. This distance is a predetermined maximum distance called DMax. The system offers a default distance which is for example 50 meters, but this distance depends on each pedestrian P and it can be changed. It is conceivable that an elderly person with reduced mobility does not want to walk more than 10 meters while a student can be ready to walk 100 meters to reach a vehicle. One can therefore associate to each pedestrian P its own predetermined maximum distance dmax.

In FIG. 2, it is shown that the route of vehicle V passes near pedestrian P, i.e. at a distance of less than or equal to the distance dmax. The vehicle V will therefore be able to stop, when it is close enough to the pedestrian P, in order to be able to take charge.

In FIG. 3, pedestrian P is too far from the route of vehicle V. This will always be at a distance of more than dmax in relation to the pedestrian P. So he won't be able to take care of him.

However, even if the vehicle V passes close enough to the pedestrian P to be able to take it on board, this does not necessarily mean that he will be able to take him to his destination.

Thus, in the case of FIG. 4, the DP and DV destinations of the pedestrian P and vehicle V are far away from a distance of less than DMax. Vehicle V can therefore transport the pedestrian P. Once the vehicle has arrived at its DV destination, the ex-pedestrian passenger P must again be pedestrian and walk a little, for a distance less than DMax, to reach its DP destination. The case where DV and DP destinations are the same or remote from a distance of less than or equal to DMax is defined as the compatibility Type 1.

In the case of FIG. 5, the destination of pedestrian P is different from that of vehicle V and is far away from the distance of DMax. In this case, the pedestrian P may not be supported by the V vehicle, otherwise it should walk a longer distance than it is willing to accept.

FIGS. 6 and 7 are diagrammed two other cases. In the case of FIG. 6, the DP destination of the pedestrian P is far removed from the DV of Vehicle V, but is at a distance less than DMax from a point PTmin of Route IV of Vehicle v. This means that vehicle V will be able to drop the pedestrian P near its DP destination, it will just have to stop along the way. The PTmin point will then be memorized by the S server. Then, once the vehicle is at the PTmin point, it will have to stop so that the pedestrian P can go down and reach its DP destination by walking a distance less than DMax. The case where the pedestrian's DP destination is on Route IV of vehicle V or at a point PTmin away from a distance less than or equal to DMax of that route is defined as the type of Compatibility 2.

On the other hand, in the case of FIG. 7, no point in the vehicle route passes close enough to the pedestrian's DP destination. This means that although the initial position of the pedestrian P is close enough to the route of the vehicle V so that it can be mounted, the DP destination is too far away from this route so that the pedestrian can be brought close enough by Vehicle V.

An example of flowchart detailing the steps for the server S of the principle of determining the compatibility of the routes is shown in FIGS. 8 and 8bis.

Linking of the Pedestrian P with the Vehicle V

If it turns out, on the one hand, that the pedestrian P can be taken over by vehicle V and, on the other hand, that it can take it to its DP destination or drop it close to it, the system can then send a signal of possibility of taking over both the Pedestrian p, in order to inform him that he can and will be taken to his DP destination or near it and he also sends a signal of possibility of taking over to the vehicle p, so that he knows that he will have to stop to let up a pedestrian p.

Preferably, the signal specifies whether the vehicle V must take the pedestrian P to its DV destination (type 1 compatibility) or whether it should be deposited at a PTmin intermediate location on its route IV (Type 2 compatibility).

The connection of the pedestrian P with the vehicle V is preferably carried out in the following way:

The S server calculates the current distance d3 between vehicle V and pedestrian P,

then it compares this distance D3 to DMax;

If D3 is greater than dmax, it means that vehicle V is still too far from the pedestrian P to be able to take over it; The S server must therefore return to the previous step of determining D3;

and so on until D3 is less than or equal to DMax, in this case:
The S server sends a stop signal to the TV terminal to inform the driver that he must stop the vehicle V;
At the same time, or just before, or just after, the server S sends a support signal to the TP terminal in order to invite the pedestrian P to mount in vehicle V after possibly market if necessary for a distance of less than or equal to DMax;
The pedestrian P then activates the keyboard and/or the screen of his TP terminal and/or informs him vocally, so that he sends a signal of ascent in the vehicle to the server S to inform him that the support has taken place,
and/or the driver of the vehicle V activates the keypad and/or screen of the TV terminal and/or informs it vocally, so that it sends a pedestrian ascent signal to the server S to inform him that the support has taken place,
then the TV terminal regularly sends its current position GLV to the server S;
In case of type 1 compatibility, the S server compares the current position of the vehicle V to the DV destination, if the difference is less than or equal to DMax, the server sends a stop signal to vehicle V for it to stop and let the ex passenger down—Pedestrian P and the driver also goes down in principle from his vehicle; The passenger P then operates its TP terminal so that it sends an end-of-transport signal to the S-server and/or the driver activates the TV terminal so that it sends an end-of-transport signal to the s server;
In case of type 2 compatibility, the server S compares the current position of the vehicle V at point PTmin; If there is a difference, then it waits for a new current position of the TV terminal; If there is an identity between the current position and the PTmin point, the S server sends a stop signal to the TV terminal so that the driver knows that he has to stop his vehicle V to let the passenger down P; Alternatively, it can be foreseen that the server S measures the distance between the current position of the vehicle and PTmin and as soon as it is below a certain threshold, it already sends the stop signal, this is preferable if one considers that the vehicle V can roll Quickly and that it takes a certain distance to stop;
After its descent from vehicle V, the passenger P can activate the keyboard and/or the display of his TP terminal and/or inform the latter vocally, so that he sends to the server S a signal of end of transport;
and/or once the pedestrian has descended, the driver P can activate the keyboard and/or the screen of his TP terminal and/or inform the latter vocally, so that he sends to the server S a signal of end of transport.

An example of flowchart detailing for the server S the steps of the principle of relationship that has just been explained is shown in FIGS. 9 and 9bis.

Example of Realization

The server includes or has access to one or more memories that may include:
A base of registered pedestrian users, with personal data of pedestrians, such data may include, the identity (surname, first name . . . ), the sex, the maximum distance predetermined dmax desired, the refusal to travel in the company of a smoker or a Animal (dog, cat, ferret, etc.); Possibly payment data for example, the credit card number or a Skype® account identifier;
A driver user base registered with
   Data relating to these drivers, such data may include personal data of drivers, such as identity (surname, first name . . . ), sex, being a smoker, the usual presence of an animal (dog, etc.);
   Vehicle data, such as one or more photographs (for example, face, back, side, perspective, etc.), the type of vehicle, its model, its colour, its licence plate, the number of persons the driver is willing to take in Load simultaneously;
   Data relating to the receipt of entries at the expense, for example, bank details or a Skype® account identifier, and the sum of the travel distances travelled;
A base of pedestrians seeking support, with their initial positions and destinations and fresh personal data relating to these pedestrians, such as their “selfie”;
A base of drivers providing support, with their initial positions and destinations and fresh personal data relating to these drivers, such as their “selfie”;
A basis for compatibility couples;
A passenger base, i.e. pedestrians who have just been associated with a vehicle and are going to be taken care of or already are. This database contains information on the current GLP positions, the signals emitted by the TP terminals;
A base of carriers, i.e. vehicles that have already been associated with one or more pedestrians and who will take care of them or have already taken care of them; This database contains information on the current GLV positions, the signals emitted by the TV terminals;
Optionally a geographical memory intended for the calculation of routes and/or containing the location coordinates of certain destinations.

The CPU or microprocessor of the server can periodically update the base of the passengers and the driver base, or leave this task to a coprocessor.

The S server is preferably able to receive at least the following signals:
Support request signal from a pedestrian terminal TP;
Support offer signal from a vehicle or vehicle driver's TV terminal;
Signal of ascent in a vehicle from a pedestrian TP terminal;
End-of-transport signal from a pedestrian TP terminal;
Possibly a pedestrian's ascent signal from a vehicle TV terminal;
Possibly a pedestrian's ascent signal from a vehicle TV terminal;
Possible end-of-transport signal from a vehicle TV terminal;
Possibly end of transport signal from a pedestrian TP terminal.

These signals have in principle a coded form allowing the server to distinguish between them and store them in the bases to which they correspond.

The S server is preferably capable of transmitting at least the following signals:
Signal of possibility of support for a pedestrian TP terminal including fresh personal data relating to a driver;
Signal of possibility of support for a vehicle TV terminal, including fresh personal data relating to a pedestrian and possibly an indication of the type of compatibility 1 or 2;
Signal, intended for pedestrian (or driver) refusal of support by a driver (or a pedestrian respectively);
Invitation signal, intended for a pedestrian TP terminal, to invite the latter to ride in a vehicle;
Pedestrian ascent stop signal, intended for a vehicle TV terminal, for the driver to stop the vehicle in order to allow a pedestrian to climb;
Passenger descent stop signal, intended for a vehicle TV terminal, for the driver to stop the vehicle in order to let down a pedestrian;
Eventual signal of arrival at destination destined for a vehicle TV terminal for the driver to stop his vehicle;
Eventual signal of arrival at destination destined for a pedestrian TP terminal, so that it descends from the vehicle carrying it;
Possibly, no compatibility signal for a vehicle or pedestrian.

These signals can also be coded.

Pre-Registration of Pedestrians and Drivers

The registration of pedestrians and drivers may be done by means of a computer or terminal connected to the Internet and accessing a website relating to the invention.

Once on the site, the pedestrian or driver either register by choosing either an inscription as a pedestrian user or as a driver user.

It therefore chooses a username and password to create a pedestrian or driver user account, and then seizes the aforementioned information which is intended to feed the registered pedestrian base or the registered driver's base.

Alternatively, the pedestrian or driver can register by means of its TP or TV terminal, by opening the Web browser of its terminal to go to the website of the invention or by opening an application reading a QR code referring to the website of the invention , then download an application intended to implement the process according to the invention in cooperation with the server S. It can also go to a platform for downloading applications such as platforms known as APP Store®, Google® Play Store, Windows store®etc.

When the application is first opened, it invites the pedestrian or driver to register it in a manner similar to what it might do on the invention website.

When registering, the pedestrian user may choose between several pedestrian user formulas, including a subscription allowing him to use the system according to the invention for a specified period of time, or a purchase of transport units.

Payment can be made by means of a credit card payment module, or by means of a Paypal® account, or by any other appropriate means.

As for the driver user, he can choose to receive an interest in transportation costs. He then seizes his bank details, his email address for the Paypal system®, etc., depending on the payment modules available.

In addition, there may be a verification or validation of the identity of the pedestrian or driver, for example, by crossing the personal data with those of another system or Web site, as is the case for example the application Airbnb® By referring to the LinkedIn® or Facebook site®.

The registration is completed and the pedestrian or driver has a user account.

An example of a flowchart detailing the pre-registration steps is shown in FIG. 10.

Common Use-Travel Management Principle

The invention is optimally implemented when the pedestrian or driver has downloaded and installed on his or her terminal TP or TV an application implementing the invention.

The user launches or opens the application. Depending on the configuration he has chosen, he can enter his username and password. The system recognizes it and then immediately determines whether it is a pedestrian or a conductor and the application goes into the corresponding mode, pedestrian or driver.

Of course, the user may have configured his application to have to retype each time his password, or even to have nothing to enter.

The pedestrian or driver user then seizes or dictates his DP or DV destination and provides fresh personal data concerning him, for example by simply doing a “selfie”.

One of the strengths of the invention is that the user does not have much more to do, except accept/refuse the support offered to him.

Application in the Usual Pedestrian Mode

The application commands the pedestrian's TP terminal to send a support request signal to the server. This normally includes the user's ID, current position, destination and fresh personal data concerning him, for example, a “selfie” he has just done.

If the pedestrian user uses the subscription formula, the server checks whether or not the pedestrian user's subscription has expired. If so, the S server sends a subscription renewal proposal to the TP terminal as well as a proposal to move to the transport unit formula, indicating the minimum number of transport units to be purchased that it has just calculated at From the initial GLP position and the DP destination. The server S then manages the communication with the TP terminal necessary for payment (payment module, etc.). In the case of purchase of transport units (UT), it verifies that the number of transport units purchased is greater than or equal to the minimum number above. If not, it remakes the above-mentioned proposals.

If the pedestrian user uses the transport unit formula, the server calculates the distance between the initial GLP position of the pedestrian and its DP destination and the minimum number of transport units. It then compares this number to the number of transport units remaining on the user's account and in case of inferiority, proposes to the user to redeem units, mentioning to him the minimum number that he has just calculated. It verifies that the number of transport units purchased is greater than the minimum number above. If not, it reiterates the aforementioned proposal and also proposes to the pedestrian to move on to the subscription formula. The server S then manages the communication with the TP terminal necessary for payment (payment module, etc.).

The pedestrian is not supposed to move, as any movement can cause it to get away from the vehicle route and it may no longer be able to be taken care of if it is beyond the dmax distance.

However, the application can be expected to manage the TP terminal so that it regularly communicates its current position to the S server.

The TP terminal then waits, on the part of the S server, for a possible support signal. Once this signal is received, it emits an audible and/or visual signal and/or a vibration to the pedestrian, and it displays the fresh personal data relating to the driver (photo . . . ) as well as possibly the evaluation (Woman/Man) of the driver, The number of transports or the transport numbers (woman/man) carried out. The TP terminal also displays a request for acceptance or refusal of support and waits. If the pedestrian refuses the support, the terminal communicates the information to the server which will search for a new compatibility and propose a new driver. The pedestrian must therefore wait for a new signal of possibility of taking over.

If the pedestrian accepts the support, the TP terminal communicates the information to the server and then waits for the S server to send him an audible and/or visual signal and/or an invitation vibration to be mounted in the vehicle, with information relating to the vehicle (photo, color, type, model . . . ) and fresh personal data concerning the driver of the vehicle (photo . . . so that the pedestrian can identify both the vehicle and the driver who will take care of it. This information is communicated by the TP terminal in a visual, audible and/or vibratory manner to the pedestrian. They make it possible to increase the security of the system. In fact, if the pedestrian finds that the vehicle's data or the driver's personal data (“selfie” . . . ) are different from those announced to him, either it is not the right vehicle or the driver has changed or falsified his Appearance, in this case the pedestrian can simply refuse to ride in the vehicle.

The TP terminal then waits for the pedestrian to inform him, by pressing a key on the keyboard, by clicking on the terminal screen if it is tactile, and/or vocally, that it is properly mounted on the vehicle and then sends to the server S a signal of ascent in the Vehicle.

Then the vehicle starts and goes to its DV destination. It then passes through the PTmin point or joins its DV destination. The pedestrian then normally descends from the vehicle. The TP terminal waits for the pedestrian to inform him, by pressing a key of the keyboard, by clicking on the screen if it is tactile, and/or vocally, that it is well descended from vehicle V. The TP terminal then sends a pedestrian end-of-transport signal to the server S.

It can also be foreseen that prior to the descent of the pedestrian, the TP terminal of the latter receives from the server S a signal of arrival at destination and communicates this information in a visual, audible and/or vibratory manner to the passenger. This information will confirm the announcement made by the pedestrian's arrival conductor at its DP destination or at a distance below DMax.

The application can then close.

An example of flowchart detailing the steps of the application's pedestrian mode is shown in FIGS. 11 and 11bis.

Application in Usual Driver Mode

The application controls the TV terminal of the vehicle or driver to send a support offer signal to the server. This normally includes the user's ID, current position, DV destination and fresh personal data concerning him, for example, a “selfie” he has just done.

The application manages the TP terminal so that it regularly communicates its current position to the S server.

The TV terminal then waits, on the part of the S server, for a possible support signal. Once this signal is received, it emits an audible and/or visual signal and/or vibration to the driver, in order to inform the conductor that it can take someone in charge. It displays the fresh personal data relating to the pedestrian (photo . . . ) as well as possibly his or her evaluations (woman/Man), the number of transport or the transport numbers (Woman/man) which he has benefited. The TV terminal also displays a request for acceptance or refusal of support and waits. If the driver refuses the support, the TV terminal communicates the information to the server which will inform the pedestrian, look for a new compatibility and propose a new pedestrian to the driver. In the meantime, the driver can roll and continue to head towards his DV destination.

The possibility of the proposed support to the driver may indicate what type of compatibility it is, i.e. whether the driver will have to take the pedestrian to the destination of vehicle V, or drop it at an intermediate point PTmin of his itinerary.

The TV terminal then waits for the S server to send a sound and/or visual and/or vibratory stop signal to allow a pedestrian to climb, including the fresh personal data relating to the pedestrian (photo . . . ). This data is communicated by the TV terminal to the driver. The TV terminal can be expected to emit a short-range preference signal, such as the Bluetooth® type to a light on the vehicle hood V and emitting a particular green light, for example, so as not to be confused with other Vehicles (police, ambulance, etc.). It can also be foreseen that the TV Terminal operates the vehicle's audible alarm V or the vehicle's headlights (call for headlights, emergency lights . . . ), so that the pedestrian can locate it.

Since vehicle V is at a distance of less than or equal to DMax, the pedestrian has no difficulty locating it.

Thanks to the fresh personal data about the pedestrian provided by the S server, the driver can make sure that it is the right person. In fact, for example, if the photograph of the pedestrian does not correspond to that which was communicated during the proposal of support, there must be an error or a trap and the driver can not unlock the doors of his vehicle.

The TV terminal then waits for the driver to inform him, by pressing a key on the keyboard or by clicking on the terminal screen if it is tactile, and/or vocally, that the pedestrian is properly mounted on board the vehicle, then sends to the server S a signal Support driver.

Then, if one is in the case of type 1 compatibility, the TV terminal waits on the server S a stop signal to let the passenger down. The TV terminal communicates this information in a sound, visual and/or vibrating manner to the driver.

Eventually, the TV terminal waits for the driver to inform him, by pressing a key on the keyboard or by clicking on the screen if it is tactile, and/or vocally, that the pedestrian has descended well. The TV terminal sends to the server S an end-of-transport signal.

If the compatibility is type 2, since the vehicle V has not arrived at the destination, it can still possibly take a new passenger. The TV terminal therefore returns to the waiting stage of a support possibility signal that the S server can send it or possibly a signal to arrive at destination. In this case, it communicates this information in a visual, audible and/or vibratory manner to the driver and closes the application.

Of course, if the vehicle is intended to carry a second person, the TV terminal can receive, before having deposited the first passenger, a second signal of possibility of taking charge in order to take this second person to its destination DV or At an intermediate PTmin point. As with the first person, the vehicle can accept or refuse this second support. In case of acceptance, the server S at the same time handles the support and transport of the 2^{Th} Passenger in the same way as if it were a first passenger. It goes without saying that this second passenger does not necessarily have the same type of compatibility as the first passenger and can even, if necessary, get off before the first passenger.

The same is the case if the vehicle can carry a third passenger or other passengers.

It is obvious that after having deposited a passenger, the driver can close his application if he no longer wants to carry passengers.

An example of flowchart detailing the steps in the application's driver mode is shown in FIGS. 12 and 12bis.

Server S Overall Operation

The S server can operate both in a mode of managing the registration of pedestrian users and drivers and in a traffic management mode, these modes can run successively or parallel.

Registration Management Mode

Once started, the S server can wait for a request to register a pedestrian P. He then communicates with the TP terminal of the pedestrian P to receive the information relating to the pedestrian and the payment. It then stores the pedestrian p data in the base of the registered P pedestrians.

Then the server S expects the arrival of a request for registration of a vehicle V. It then communicates with the TV terminal of this vehicle to receive information about the driver of the vehicle and the bank or Paypal information®. It then stores the data for vehicle P and its driver in the registered driver's base.

The details of the execution of the prescriptions have already been described previously and illustrated by the flowchart in FIG. 10.

Traffic Management Phase

The server S expects to receive a support request from a pedestrian P, each request including at least the initial GLP position of the pedestrian, or rather, its TP terminal, and its DP destination.

Since this is an application for support, this means that the pedestrian p is already in the base of the pedestrians P enrolled. The server S then consults this base to find out if its subscription is still valid or if it still has transport units. If not, it manages communication with the pedestrian's Tp terminal, in order to allow it to have access again to the system, either by renewing its subscription or by purchasing transport units.

The server S then stores the pedestrian p in its base of the pedestrians p supporting applicants.

The server S expects to receive a request for a support offer from a V vehicle, each offer including the current GLV position of the vehicle, or rather its integrated TV terminal (or owned by the driver), as well as the DV destination of the vehicle V.

Since this is a request for an offer of support, this means that the driver and his vehicle v are already in the base of vehicles v registered.

The S-server then stores vehicle V in its supporting supply vehicle base.

By repeating these operations as it receives requests and support offers, the server S feeds the corresponding databases.

This way of feeding the bases of support applicants and offerors is illustrated by the part of flowchart visible in FIG. 13.

If there is already at least one pedestrian P requesting support and at least one vehicle V support Offerer, one can already know if there is compatibility between them.

Then the server S takes one by one, all the pedestrians p lying in the base of the pedestrians P applicants for support, and search for each of them a compatible vehicle.

For each pedestrian P, he will examine all vehicles present in the base of vehicles v pickers and see if any of these vehicles has a compatible route with him, that is to say that he first looks if the vehicle V will pass close enough Of the pedestrian P to be able to stop and get him up. If this is not possible, it means that there is incompatibility of the routes, so there is no point in examining the destinations of the pedestrian DP and the DV vehicle and then we can move on to the next vehicle.

But if the V vehicle is going to pass near the pedestrian P, he will be able to get it aboard. The S server then determines whether it will be able to take it to its DV destination or drop it along the way, somewhere at a point PTmin from Route IV of vehicle V.

This compatibility determination has already been described above and illustrated by FIGS. 8 and 8bis.

The itinerary is not necessarily rectilinear and its calculation can be done in various ways, by accessing A geographical memory or because An electronic card Planned for the calculation of routes, as we know it for a long time (cf. FR 2 894 364, the patent applications mentioned in introduction, Google Maps, Applications Michelin®, the Backpacker®, Citymapper™, Here™ . . . ) or by searching for data provided by Other Systems (Www.route4me.com, etc.).

If a V vehicle has a route compatible with the pedestrian P considered, the server S forms a couple with these pedestrian and vehicle, called Compatibility Couple (Pi, Vj), and it stores this couple in the compatibility couple base. Pi is here the pedestrian considered, among the n pedestrians present in the base of the pedestrians applicants for support and VJ is the compatible vehicle or at least the first that server found, among the M vehicles contained in the base of the vehicles supplying in CH Arge.

If no V vehicle has a pedestrian-compatible route P, it must wait until a compatible vehicle is introduced into the base of the supporting vehicles.

In the meantime, the server S passes to the next pedestrian and re-examines all the vehicles, to try to find one whose route is compatible.

Thus, for the compatibility determination, I varies from 1 to N and J varies from 1 to M.

Once a pedestrian is part of a compatibility couple, he is no longer taking charge (since he has found . . . ) and he can therefore be taken out of the base of the pedestrians seeking support and introduced into the passenger base.

For vehicles, the situation is a little more complicated because a vehicle can transport or accept to carry several ex-pedestrian passengers at the same time. If one calls “L” the number of passengers that the driver of the vehicle is willing to take over at the same time, once a compatibility couple has been formed by this vehicle with a pedestrian, it is necessary to decrement the value of L. Only when L is null that the vehicle can be removed from the base of the pick-up vehicles does not charge. The vehicle is introduced into the carrier base.

Once the vehicle V has taken a passenger, if the number L is still greater than or equal to 1, it may take another one which it will deposit before, after or at the same time as the first passenger. So it remains in the base of the vehicles supplying support.

In other words, a vehicle can at the same time be present in the base of the supporting vehicles and in that of the carriers.

Thus, the server S reviews all pedestrians and all vehicles, to train, whenever possible, compatibility pairs (pedestrian, vehicle).

Pedestrians who have not found takers remain temporarily in the base of the pedestrians seeking support.

Similarly, the vehicles for which the S server found no pedestrians remain in the pedestrian base. Tentatively, because the bases of pedestrians applicants and drivers offerers are enriched regularly and new compatibilities can appear.

This way of forming compatibility pairs is illustrated by the flowchart part of FIG. 13bis.

The processing of accept/reject requests for support is illustrated by the part of flowchart that is the subject of FIG. 13bis2.

Then, for all the compatibility pairs that are formed, the S server can handle the connections. Specifically, for each compatibility couple (pi, Vj), the S server becomes the intermediary between the pedestrian Pi and a Vj vehicle, as explained previously.

The principle of relationships has already been explained earlier and illustrated by FIGS. 9 and 9a.

Once a passenger has been deposited and its TP terminal has transmitted a pedestrian end-of-transport signal to the server s, the s server can calculate the corresponding transport distance that has been travelled and add it to the sum of the distances travelled Already found in the base of registered drivers, in connection with the driver who has just carried out this transport. The new sum is then stored in the registered drivers' base and will later be used to pay the driver Pi.

Once a passenger has been deposited, the compatibility torque it formed with the VJ vehicle (Pi, VJ) can be removed from the compatibility couple base.

At this stage, it can be foreseen that the information relating to each compatibility pair, such as the time (date, time, minute) of their formation and the time (date, time, minute) of their exit from the base of the compatibility pairs are stored in a Archival memory, which may be consulted by the police or the judiciary in case of crime, etc., or for the establishment of statistics on the functioning of the system.

The generalization of the connections is illustrated by the part of flowchart of FIGS. 13ter and 13quater, because FIGS. 13 to 13quinter illustrate in fact the process according to the invention of management of the movements of a set of pedestrians (P) by means of a Ev set of Vehicles (V).

The server can be configured to perform periodically, for example once a month, preferably at the end of the month and advantageously at off-peak hours, i.e. normally in the middle of the night, a driver's remuneration. For this, he consults the base of registered drivers and for each driver of this base, he multiplies for example the sum of the distances travelled by a coefficient of participation at the expense.

The money collected during subscriptions or purchases of transport units of registered pedestrians, is normally on an account (bank or Paypal®, etc.). The S server may search the registered drivers' database for the payment data of each driver and transfer, from the aforementioned account to each driver's account, the contribution to the fee.

This calculation of the financial holdings is illustrated by the part of flowchart in FIG. 13quinter.

Of course, it is possible to provide a total free system, but it is unlikely that the system will be very successful with drivers if they do not receive a share of the costs that the transport has caused them.

Thus, in common use, that is to say once the application is installed on a terminal TP and the pedestrian P registered, whenever it needs to be transported, it will only have to open the application, seize or dictate its destination, make a “Selfie”, to wait until he is offered a pick-up, accept/refuse this assumption, then once he has accepted a proposal (and the latter has been accepted by the driver of the proposed vehicle), wait for him to be invited to join the Vehicle that will be shown to fit in and be transported to or near the destination.

As for the driver, in common use, that is, once the application is installed on a TV terminal and the registered driver, whenever he is willing to carry a pedestrian, he will only have to open the application, seize or dictate his Destination, do a “selfie”, wait for him to be offered a pick-up, accept/refuse this assumption, then once he has accepted a proposal, to wait until he is asked to stop to bring that person up, then to take him to Its DV destination or drop it at an intermediate location PTmin located on its route IV and the server S will tell it.

Variants & Supplements

The pedestrian mode of the application, which preferably offers the possibility of modifying the preferences of the pedestrian, in particular the distance dmax, can also provide a dmax1 distance for the initial support and a higher dmax2 distance for the arrival at Destination. It is possible to envisage that for a transport of an urban area with high vehicle density, towards a destination in a remote rural area, the pedestrian does not wish to move for a long distance in the city but is ready to walk more once in zone Rural.

The pedestrian mode of the application may also include in its preferences a red list of drivers, so as to avoid that it is proposed to the pedestrian to travel with certain persons. For example, one can imagine that a woman does not want to be taken charge by a vehicle driven by a man, etc.

Similarly, the application's driver mode can also exclude certain categories of people from its preferences.

Pedestrian or driver modes of the application may also exclude the presence of an animal (dog, ferret, etc.).

It can also be foreseen that the program in pedestrian or driver mode allows a cancellation of the planned support or this cancellation of automatically performs in case of abrupt shutdown of the program. In this case, it is desirable that the server informs the other travel partner.

A passenger may, for one reason or another, ask the driver to let him off the vehicle earlier. In this case, it may be envisaged that the passenger's TP terminal can inform the server of the end of transport before arrival at destination, so that the driver can still be defrayed on the basis of the shorter than expected route travelled in common with The ex-pedestrian passenger.

The terminals can be expected to simplify the seizure or dictation of a destination, using keywords, for example, “tour” for the Eiffel Tower (Paris, France), “Coli” for the Colosseum (Rome, Italy), “jet” for the Water Jet of Geneva (Switzerland), “Copa” for The Copacabana district (Rio de Janeiro, Brazil, etc.)

In pedestrian or driver modes, verification of the username/password is performed locally, i.e. at the TP or TV terminal, but it can also be expected to be performed by the server S.

We can also predict:

Applications or server S are able to manage a module, A subroutine or an iteration Password recovery or re-creation,

That the TPi terminal of the pedestrian Pi allows the latter to modify the predetermined maximum distance dmax and to send the modified value to the server S and

That the transport distance of the passenger P by a vehicle v be memorised and, where appropriate, added to the preceding transport distances, a summary being carried out periodically for all vehicles V and the total distance of transport of each Vehicle V for a given period of time used as a calculation for the remuneration of the driver of the vehicle v concerned.

Supplement A

Has) Method of Facilitating Travel

In the process of facilitating the movement of an Ep group of pedestrians (P) each equipped with a portable terminal (TP) by means of an Ev set of vehicles (V) associated with or each equipped with a terminal (TV), it Can be expected that the server (S), before sending to a pedestrian (PI) a signal of possibility of support, estimates the approximate time necessary to the vehicle (VJ) of the compatibility torque [Pedestrian (pi); vehicle (VJ)], to reach the pedestrian. Then, this time is integrated with the signal of the possibility of support addressed to the pedestrian (Pi).

For the estimation of this time, the server (S) calculates the distance between the vehicle (VJ) of the Pedestrian (Pi), then, several scenarios can be envisaged:
If the vehicle is in motion, the server (S), determines through the successive positions communicated to it by the geolocation, the speed of the vehicle and then computes the time with the distance and that speed;
If the vehicle is stationary, the server (S) assumes that the vehicle will roll at an average urban speed of 50 or 40 km/hour and then calculates the time; It can also be expected that the server (S) will determine through geo-location data if the vehicle is located in urban or rural areas; Then, if it is an urban area, it calculates time by taking an urban speed of 50 or 40 km/hour; If it is a rural area, the server can do the calculation on the basis of a rural speed of 80 or 90 km/hour.

The fact of indicating to the pedestrian in how long it will be taken care of in particular allows him not to worry if this long may seem long.

Of course, it can be foreseen that the server also communicates this time to the driver of the VJ vehicle when he offers him the support of a pedestrian Pi, in particular to make him aware and not to surprise him when he asks him to stop.

In addition, when displaying the assessment of a pedestrian or driver (a case described in particular in the aforementioned European patent Application No. 15003547), it may be foreseen, for example, that by clicking on an area of the screen, pressing a key or Dictating an order, it shows a detail of the evaluations, in particular, according to age groups. In this way, a driver could, for example, have an average assessment based on assessments made by women aged 18 to 28, an average assessment based on assessments made by women aged 29 to 39 and so on.

This would increase the sense of security for some people.

Finally, generally speaking, it may be expected that by pressing a key or area of the screen or by dictating an order, any pedestrian and any driver can cancel the assumption at any time.

b) Compatibility Determination Method

In the process of determining the compatibility of the IPi route of a pedestrian pi equipped with an TPi portable terminal with the Plei itinerary of a VJ vehicle equipped with a TVJ terminal, with a view to the latter's support of the pedestrian pi, it Can be expected The server will take into account the movement of the Vj vehicle. In fact, it is necessary to avoid that the Vj vehicle has already exceeded the pedestrian when it receives the proposal to take over the latter.

If the Vj vehicle is stationary, the problem does not arise.

But if it is in motion, then it is necessary to calculate its speed and then the time necessary to reach the pedestrian (for example as indicated in the preceding paragraph) and it is necessary to take into account the decision time (acceptance/refusal of the assumption) of the Pedestrian, preferably also of the decision time (acceptance/refusal of the support) of the driver, possibly of the telecommunication time of the signals, possibly of the time of processing of the information by the server (S) and if necessary by Pedestrian and driver terminals, and preferentially provide for a time (a margin) of safety, especially in the event that the telecommunications network is slow and delays the sending of messages.

Thus, if the time required to reach the pedestrian is less than the sum of the times mentioned above, the server should conclude that the routes are not compatible.

It goes without saying that the existence of the predetermined maximum distance dmax should also be taken into account, because by allowing a vehicle to stop after having exceeded the pedestrian but staying at a distance less than DMax, a management should Still be possible.

Moreover, so far, for each pedestrian pi, VJ vehicles were examined to see if their route was compatible, and then a compatibility pair was formed as soon as the route of a pedestrian pi was compatible with the itinerary of a VJ vehicle.

It goes without saying that we can start with Vj vehicles rather than pedestrians Pi. In other words, one can, for each VJ vehicle, examine one by one all pedestrians pi to see if their route is compatible, then form a compatibility couple as soon as the itinerary of a VJ vehicle is compatible with the route of a pedestrian pi.

Anyway, these ways of doing things are interesting when the server has to manage a large number of pedestrians and/or vehicles.

However, a variant can be considered when the server has little information to deal with in relation to its processing capabilities. Specifically, for each pedestrian Pi, one could review all Vj vehicles, not stopping when there is compatibility. One could thus have several compatibility and thus several compatibility pairs (pedestrian Pi; vehicle Vj). These couples would be memorized as they were trained. Once the last VJ vehicle was examined, one could then compare all the trained compatibility pairs to determine and choose the one for which the distance between the VJ vehicle and the pedestrian Pi is the smallest. The other couples would then be eliminated. This would have the advantage of proposing to a pedestrian Pi the nearest VJ vehicle and therefore the fastest support, so that it can get to its destination as quickly as possible.

The above applies obviously also when you start by taking a Vj vehicle and then one by one examines all the pedestrians Pi.

However, these ways of doing things—by choosing from several compatibility pairs—multiply the tasks performed by the server and can therefore slow it down if they are too numerous because of a number of pedestrians and/or vehicles too high.

It can then be expected that the server will choose between the two accounting torque determination systems (s). For example, if the number of pedestrians and/or the number of vehicles exceeds a certain threshold, one switches from the slow compatibility determination mode (choice among several compatibility pairs) to the fast determination mode (shutdown as soon as a compatibility is found and only the corresponding pedestrian/vehicle pair is trained.

According to another variant, the compatibility determination is not based only on the routes and possibly the time of hit and the pedestrian/vehicle distance as explained above, but it takes into account the preferences indicated in Initial inscription of pedestrians and drivers.

Thus, once a compatibility is determined, it must be consistent with the requirements of the pedestrian and the driver.

In other words, once a compatibility based on the routes (and possibly the time of reaching and the distance) determined, it must be verified that it is acceptable in the light of the requirements or exclusions The pedestrian and the driver's.

For example, if a pedestrian has registered in its preferences when registering or later, that it does not want to travel with a man, if the server finds compatibility on the basis on routes (and possibly the time of reaching and of the distance), he must then review the requirements of this pedestrian. He will then see this refusal to travel with a man and eventually conclude with a lack of compatibility.

Similarly, if, for example, the pedestrian agrees to ride in a vehicle driven by a man, but is with his dog and the driver has indicated in his preferences that he refuses to carry a dog, the compatibility will be discarded on the basis of Preferences or exclusions o the driver and not of the pedestrian.

Compliance with the requirements or exclusions Pedestrians and drivers can be verified in the first place by the server: This can therefore before looking for compatibility based on the routes (and possibly the times of hit and distances), to remove from office certain refusals, As in the example above, a vehicle whose driver is a man, before moving on to the next vehicle, without examining the routes.

It goes without saying that it is desirable to examine only a minimum of the requirements of pedestrians and drivers because this review of all these conditions multiplies the tasks of the server and thus slows the operation of the whole system.

Supplement B

a) Method of Facilitating Travel

In the processes—the aforementioned patent applications—facilitating the movement of an Ep of pedestrians (P) each equipped with a portable terminal (TP) by means of an Ev set of vehicles (V) associated with or each equipped with a terminal (TV), it is now Proposed that the server (S), before sending to a pedestrian (Pi) a signal of possibility of support:
Calculates the distance between the vehicle (VJ) of the Pedestrian (Pi);
If and only if this distance is greater than a predetermined distance, for example 10 kilometers, the server (S) estimates the approximate time required for the vehicle (VJ) of the compatibility torque [pedestrian (Pi); vehicle (VJ)], to reach the pedestrian. Then, this time is integrated with the signal of the possibility of support addressed to the pedestrian (Pi).

For the estimation of this time, the server (S) calculates the distance between the vehicle (VJ) of the Pedestrian (Pi), then, several scenarios can be envisaged:
If the vehicle is in motion, the server (S), determines through the successive positions communicated to it by the geolocation, the speed of the vehicle and then computes the time with the distance and that speed;
If the vehicle is stationary, the server (S) assumes that the vehicle will roll at an average urban speed of 50 or 40 km/hour and then calculates the time; It can also be expected that the server (S) will determine through geo-location data if the vehicle is located in urban or rural areas; Then, if it is an urban area, it calculates time by taking an urban speed of 50 or 40 km/hour; If it is a rural area, the server can do the calculation on the basis of a rural speed of 80 or 90 km/hour.

The fact of indicating to the pedestrian in how long it will be taken care of in particular allows him not to worry if this long may seem long or to care while waiting so as not to stay without doing anything by probably annoying.

Of course, it can be foreseen that the server also communicates this time to the driver of the VJ vehicle when he offers him the support of a pedestrian Pi, in particular to make him aware and not to surprise him when he asks him to stop.

b) Fresh Data (Selfies, “Gifies”, Mini-Video, etc.)

If the driver has at least one initial passenger, once he has taken his selfie (or “gifie”, mini-video, etc.), he can be expected to add this original passenger and take his picture (or make a “gifie”, a mini-video, etc.).

In the proposal for support sent to the pedestrian, the two photos (or “gifies”, mini-videos, etc.) will be displayed and they will also be shown later, just before the vehicle stops to allow the pedestrian to climb, in addition, of course, at that time, of The photo of the car.

But the server must content account of this initial passenger in his calculations, as this decreases the number of places available in the vehicle.

If this initial passenger is known to the system (already registered as a passenger) the system preferably also displays its evaluations and preferably also the number of transports it has benefited.

Similarly, it may also be possible for the passenger to add at least one person and photograph (or make a “gifie” or mini-video, etc.) of that additional person. This is interesting for example in the case where two friends want to travel together.

When requesting support to the driver, the two photos (or “gifie”, mini-video, etc.) will be displayed on the driver (or vehicle) terminal.

If this additional person is known of the system (already registered as a passenger) the system preferably also displays its evaluations and preferably also the number of transports it has benefited.

However the server must content account of this or those additional persons in its calculations, because it is necessary that the number of seats available in the vehicle is sufficient for all passengers.

Supplement C

So far it has been envisaged that the server will calculate the routes of pedestrians and vehicles. It follows that the role of their respective terminals can be considered simple. Nevertheless, since the power of the terminals is already significant and rapidly increasing, it can be envisaged that each terminal calculates the route between the starting point and the destination of the pedestrian or the driver (or vehicle) and provides the results to the server in a form quickly exploitable by it. This would have the advantage of saving calculations to the server and therefore allowing it to devote more resources to traffic management, thus making the system more responsive.

It should be noted that all aspects, variants, supplements and/or supplements described in this description may be combined partially or wholly, except, of course, in case of incompatibility or technical impossibility, what those skilled in the art will determine.

1. Method of facilitating the movement of a set (Ep) of pedestrians (P) each with a portable terminal (TP), by using a set of (Ev) of vehicles (V) each associated or equipped with a terminal (TV), said terminals (TP, TV) having or being associated with devices for detecting their current positions (GLP, GLV), said method including the following steps:
emission by pedestrians (P) of requests for transport, each request including at least the current position (GLP) and the destination (DP) of the pedestrian concerned;
emission by vehicles (V) or their drivers of offers of transport, each offer including at least the current position (GLV) and the destination (DV) of the vehicle concerned;
reception by a server (S) of the requests and offers of transport;
constitution by the server (S) of a set (Ep) of pedestrian (P) asking for a transport,
constitution by the server (S) of a set (Ev) of vehicles (V) offering a transport,
search by the server (S), for each of the pedestrians (Pi) of the set (Ep), for a vehicle (Vj) of the set (Ev) having a route compatible with that of the pedestrian (Pi) and formation of compatibility couples [pedestrian (Pi); vehicle (Vj)];
for each compatibility couple [pedestrian (Pi); vehicle (Vj)]:
delivery by the server (S) to the pedestrian (PI) of each compatibility couple (pedestrian (Pi); vehicle (Vi)), a signal of possibility of transport and a request for acceptance/refusal of the transport;
if the pedestrian (Pi) sends a refusal response to the server (s), return to the previous search step (s) by the server (S);
in the case of a pedestrian (Pi) transmission of an acceptance response, sending by the server (S) to the vehicle (Vj) or its driver, of a signal of possibility of transport and a request to accept/refuse the transport;
if the vehicle (Vj) or its driver sends a refusal response to the server (s), return to the previous search step by the server (S) and optional sending by the server (S) to the pedestrian (Pi) of a transport refusal signal;
if the vehicle (Vj) or its driver sends to the server (s) an acceptance response, optional sending by the server (S) to the pedestrian (Pi) of a transport confirmation signal;
wherein, for each compatibility couple [pedestrian (Pi); vehicle (Vj)]:
each transport request includes recent personal data (DFPi) relating to the pedestrian (Pi);
each transport offer includes recent personal data (DFVJ) relating to the vehicle driver (Vj);
and wherein
the signal of possibility of transport sent to the pedestrian (Pi) includes said recent personal data (DFVj) relating to the driver of the vehicle (Vj);
the signal of possibility of transport sent to the driver of the vehicle (Vj) includes said recent personal data (DFPi) relating to the pedestrian (Pi).

2. Method according to claim 1, further including:
a step in which each pedestrian (Pi) photographs him/her/self or is photographed by means of his/her terminal (TP) and the recent personal data (DFPi) relating to the pedestrian (Pi) include the photograph;
a step in which each vehicle driver (Vj) photographs him/her/self or is photographed by means of the terminal (TV) and the recent personal data (DFVJ) relating to the vehicle driver (Vj) include the photograph;
the signal of possibility of transport sent to the vehicle (Vj) or its driver also optionally includes the indication of the sex of the pedestrian (Pi); and
the signal of the possibility of transport sent to the pedestrian (Pi) also optionally includes the indication of the sex of the driver of the vehicle (VJ).

3. Method according to claim 1 or 2, in which the requests for acceptance/refusal of transport are valid for a specified period of time; if at the end of that period, the pedestrian (Pi) or the driver of the vehicle (Vj) did not respond, it is considered that his/her answer is negative and there is a return to the search step by the server of compatibility and formation of compatibility couples [Pedestrian (Pi); Vehicle (Vj)].

4. Method according to one of claims 1 to 3, in which the search by the server (S), for each of the pedestrians (Pi) of the set (Ep), of a vehicle (Vj) of the set (Ev) having a route (IVj) compatible with that of the pedestrian (Pi), and the formation of compatibility couples [pedestrian (Pi); vehicle (Vj)] is carried out as follows:
for each pedestrian (Pi) of the set of n pedestrians (Ep) and from the first (V1) to the last vehicle (Vm) of the set (Ev):
calculation by the server (S), for each of the points of the route (IVj) of the vehicle (Vi), of the distance (d0) between the point considered and the pedestrian (Pi), and comparison of this distance (d0) with a predetermined maximum distance (dmax);
if for all points, the distance (d0) is greater than (dmax), moving to the next vehicle (Vj+1);
if, for at least one point, the distance (d0) is less than or equal to the predetermined maximum distance (dmax):
calculation by the server (S) of the distance (d1) between the destination of the pedestrian (DP) and that of the vehicle (DVj) and comparison of this distance (d1) with the predetermined maximum distance (dmax);
if the distance (d1) is less than or equal to the predetermined maximum distance (dmax), forming of the compatibility couple [Pedestrian (Pi); vehicle (Vj)] and moving to the next pedestrian (Pi+1);
if the distance (d1) is greater than the predetermined maximum distance (dmax),
calculation by the server (S), for each of the route points (IVj) of the vehicle (Vj), of the distance (d2) between the point in question and the destination (DP) of the Pedestrian (Pi) and comparison of each distance (d2) with the predetermined maximum distance (dmax);
if, for all points, the distance (d2) is greater than (dmax), moving to the next vehicle (Vj+1);
if, for at least one point (PTmin), the distance (d2) is less than or equal to the predetermined maximum distance (dmax), recording of the point (PTmin); forming the compatibility couple [Pedestrian (Pi); vehicle (Vj)] and moving to the next pedestrian (Pi+1).

5. Process According to claim 4, further including the connection by the server (S), for each compatibility couple (pedestrian (Pi); vehicle (Vj)), of the pedestrian (Pi) with the vehicle (Vj), in the following way:
calculation by the server (S) of the current distance (d3) between the vehicle (Vj) and the pedestrian (Pi),
comparison of the distance (d3) with a stopping distance (da);
if the distance (d3) is greater than (da), return to the previous calculation step;
if the distance (d3) is less than or equal to (da),
sending by the server (S) to the terminal (TVj) of a signal for stopping the vehicle (Vj), this stop signal including the recent personal data (DFPi) relating to the pedestrian (Pi), such as his/her photo;
sending by the server (S) to the terminal (TPi) of a signal inviting him/her to join the vehicle (Vj) and enter into it, this invitation signal including data relating to the vehicle (Vj), such as its photo, as well as the recent personal data (DFCj) concerning the driver of the vehicle (VJ), such as his/her photograph;
sending by the terminal (TPi) to the server (S) of a signal of entry into a vehicle and/or sending by the terminal (TVj) to the server (s) of a signal of pedestrian entry,
sending by the terminal (TVj) of its current position (GLVj) to the server (S),
if there has been no recordal of a point (PTmin), comparison by the server (S) of the current position (GLVj) with the destination (DVI), in case of difference, return to the previous step of sending by the terminal (TVj) to the server (S) of its current position (GLVj); if there is an identity, optional sending by the server (S) to the terminal (TVj) and optionally to the terminal (TPi) of a signal indicating that the destination was reached;
if there has been a recordal of a point (PTmin), comparison by the server (s) of the current position received with the position (PTmin); if there is an identity, sending by the server (S) to the terminal (TVj) of a stop signal for the pedestrian exit and optionally to the terminal (TPi) of a signal of arrival at destination; if not, return to the previous step of sending by the terminal (TVj) of its current position (GLVj) to the server (S);
optionally, sending by the terminal (TP) to the server (s) of a signal of end of transport and/or sending by the terminal (TV) to the server (S) of a signal of end of transport.

6. Method according to claim 5, in which the stopping distance (da) is equal to the predetermined maximum distance (dmax).

7. Method according to claim 5, in which the server calculates the speed (VITj) of the vehicle (Vj) in km/h and the stopping distance (da) is equal to (VITj/10)².

8. Method according to any one of claims 1 to 7, in which the pedestrian terminal (TPi) allows him/her to modify the predetermined maximum distance (dmax) and to send the modified value to the server (S).

9. Method according to claim 5 or according to any one of claims 6 to 8 dependent on claim 5, in which, when the terminal (TP) sends to the server (S) an end-of-transport signal and/or when the terminal (TV) sends to the server (S) an end-of- transport signal, these emissions are accompanied by a rating (ECj) of the drive of the vehicle (Vj) by the pedestrian (Pi) and an rating of the (EPi) for the pedestrian (Pi) by the driver of the vehicle (Vj).

10. Method according to claim 9, further including
the calculation by the server (S) of an average of the ratings of the driver of the vehicle (Vi) to obtain a global average rating (EMCj) of the driver, the increment of 1 of the number of transports carried out by him/her and the storage of this information; and
the calculation by the server (S) of an average of the ratings of the pedestrian (Pi) to obtain a global average assessment (EMPi) of the pedestrian, the increment of 1 of the number of transports he/she has benefit from and the storage of this information.

11. Method according to claim 10, in which, for each compatibility couple [pedestrian (Pi); vehicle (Vj)]:
each signal of possibility of transport sent to a pedestrian (Pi) includes the overall average rating (EMCj) of the drive of the vehicle (Vj) and optionally also the number of transports already carried out by him/her and on the basis of which this overall average rating (EMCj) was calculated;
each signal of possibility of transport sent to the driver of the vehicle (Vj) includes the overall average rating (EMPi) of the pedestrian (Pi) and optionally also the number of transports the pedestrian (Pi) has benefit from and on the basis of which this overall average rating (EMPi) was calculated.

12. Method According to claim 10, in which:
for each vehicle (Vj), each rating (ECj) and each end-of-transport signal received by the server (S) is stored by it in relation to the sex of the pedestrian (Pi) that has just been transported and the server (S) calculates an average of the ratings attributed for the transport of women (EMCFj) and/or an average of the ratings received for the transport of men (EMCHj) ;
for each pedestrian (Pi), each rating (EPi) and each end-of-transport signal received by the server (S) is stored by it in relation to the sex of the driver of the vehicle (Vj) that has just transported him/her and the server (S) calculates an average of the ratings received for the trips made with female drivers (EMPFi) and/or an average of the ratings received for the trips made with male drivers (EMPHi) ;
and in which
each signal of possibility of transport sent to a pedestrian (Pi) includes the average of the ratings received by the driver of the vehicle (Vj) for the transport of women (EMCFj) and optionally the number of transports of women carried out and/or the average of the ratings received for the transport of men (EMCHj) and optionally the number of transports of men carried out; and optionally the overall average rating (EMCj) of the driver of the vehicle (Vj) and optionally the total number of transports he/she has carried out;
each signal of possibility of transport sent to a vehicle (Vj) or its driver includes the average of the ratings received by the pedestrian (Pi) for trips made with female drivers (EMPFi) and optionally the number of trips with women and/or the average of the rating received for trips made with male drivers (EMPHi) and optionally the number of trips made with men; and optionally the overall average rating (EMPi) of the pedestrian (Pi) and optionally the total number of transports he/she has benefit from.

13. Method according to claim 5 or any one of claims 6 to 12 dependent on claim 5, in which the distance of transport of the passenger (Pi) by a vehicle (VJ) is recorded and, if appropriate, added to the preceding transport distances, a summary is carried out periodically for all vehicles (Vj) and the total distance of transport of each vehicle (Vj) during a given period serves as calculation for the payment of the driver of the vehicle (VJ) concerned.

14. Method for managing the movement of a set (Ep) of pedestrians (P) each with a portable terminal (TP), by using a set of (Ev) of vehicles (V) each associated with or equipped with a terminal (TV), said terminals (TP, TV) having or being associated with devices for detecting their current positions (GLP, GLV), said method including the following steps, executable by the pedestrians (P) and the drivers of the vehicles (V):
a single preliminary step, for each pedestrian (P) and for each vehicle (V), of registration respectively in a registered pedestrian base and a registered driver base and then
for each pedestrian (P), a multitude of repetitions of all the following steps only, per trip:
start of a program capable of implementing the process according to one of claims 1 to 13;
optionally, personal identification;
communication of destination (DP);
communication of recent personal data;
optionally, refusal of one or more proposals of transport;
acceptance of a transport
confirmation of entry into a vehicle (V);
communication of the end of transport
optionally, rating of the driver of the vehicle (V);
for each driver of a vehicle (V), a multitude of repetitions of all the following steps only, per trip:
initiation of a program capable of implementing the process according to one of claims 1 to 13;
optionally, personal identification;
communication of destination (DV);
communication of recent personal data;
optionally, refusal of one or more proposals of transport;
acceptance of transport
confirmation of the entry of a pedestrian (P) into the vehicle (V);
optionally, communication of end of the transport; and
optionally, rating of the pedestrian (P).

15. System for facilitating the movements of a set (Ep) of pedestrians (P) by means of a set of (Ev) of vehicles (V), including
at least one terminal (TP) for pedestrian (P) provided with a device for determining its current position (GLP),
at least one terminal (TV) for vehicle (V) provided with a device for determining its current position (GLV), and
a server (S),
and in which:
the terminal(s) (TP) and the terminal(s) (TV) are capable and configured to communicate wirelessly with the server (S);
the server (S) are able and configured to communicate wirelessly with terminals (TP, PV);
the various configurations are capable of implementing the method according to any one of claims 1 to 13 or the method according to claim 14.
